(19) United States
(12) Patent Application Publication
(10) Pub. No.: US 2004/0037311 A1
(43) Pub. Date: Feb. 26, 2004

(54) Digital narrow band power line communication system

(75) Inventors: W. Paul Willes, Alpine, UT (US); Samuel C. Kingston, Salt Lake City, UT (US); Ronald S. Leahy, Salt Lake City, UT (US); Raied Mazahreh, Salt Lake City, UT (US); Ryan Hoobler, West Valley City, UT (US); Lyman Horne, Salt Lake City, UT (US); John Simonsen, Provo, UT (US)

Correspondence Address: Lloyd W. Sadler, Parsons Behle & Latimer, Suite 1800, 201 South Main Street, Salt Lake City, UT, 84111, US

(73) Assignee: Phonex Broadband Corporation, Midvale, UT

(21) Appl. No.: 10/215,418

(22) Filed: Aug. 7, 2002

(51) Int. Cl. H04J 3/16

(52) U.S. Cl. 370/465; 370/229

(57) ABSTRACT

A method and system for providing low cost narrow band digital power line communication using OFDM-like protocols to promote spectral diversity, reduce data loss, and provide higher data throughput. This invention provides a specific design to accommodate the requirements of a wide variety of communication applications and is adapted to make use of an AC power line communication within a building or facility without requiring dedicated hard wiring and does so with the advantages of OFDM but without the high costs of OFDM.

### BACKGROUND OF INVENTION

1. Field of the Invention

This invention relates to electronic communication systems and devices that provide communication between a wide variety of devices. More specifically, this invention relates to digital communication systems, which makes use of the AC power line channel.

2. Description of Related Art

A variety of electronic communication systems and devices have been developed and are widely used to facilitate wireless communication. Several approaches have been proposed that employ digital communication techniques. Typically such prior approaches are high cost implementations that are not specifically directed to requirements of power line communication channels. For general background material, the reader is directed to the following United States patents, each of which is hereby incorporated by reference in its entirety for the material contained therein: U.S. Pat. Nos. 5,745,836, 5,815,488, 5,963,557, 5,990,687, 6,005,894, 6,026,086 and 6,028,486.

### SUMMARY OF INVENTION

It is desirable to provide a communications system that provides spectral diversity, lower data loss, higher data throughput, multiple access, all in a low cost digital system adapted to the requirements of the AC power line communication channel. Moreover, it is desirable to provide systems for a variety of a communications applications that incorporate such a communications system.

Therefore, it is the general object of this invention to provide a digital communication system that makes use of the AC power line as the communications channel.

It is a further object of this invention to provide a communication system that provides spectral diversity.

It is a still further object of this invention to provide a communication system that has low data loss.

It is a still further object of this invention to provide a communication system that provides high data throughput.

It is another object of this invention to provide a communication system that is a multiple access system.

A further object of this invention is to provide a communication system that is adapted to the specific requirements of the AC power line communication channel.

A still further object of this invention is to provide a communication system that employs a low cost Orthogonal Frequency Division Multiplexing (OFDM) scheme.

Another object of this invention is to provide a home networking system that incorporates a multiple access, digital, AC power line communication system.

Another object of this invention is to provide a home networking system that incorporates a multiple access, digital, AC power line communication system.

Another object of this invention is to provide a telephony/analog/PBX system that incorporates a multiple access, digital, AC power line communication system.

Another object of this invention is to provide an embedded modem system that incorporates a multiple access, digital, AC power line communication system.

Another object of this invention is to provide an Internet distribution system that incorporates a multiple access, digital, AC power line communication system.

Another object of this invention is to provide an intercom system that incorporates a multiple access, digital, AC power line communication system.

Another object of this invention is to provide a home audio system that incorporates a multiple access, digital, AC power line communication system.

Another object of this invention is to provide a home theater system that incorporates a multiple access, digital, AC power line communication system.

Another object of this invention is to provide a Bridge/RF system that incorporates a multiple access, digital, AC power line communication system.

Another object of this invention is to provide a camera security system that incorporates a multiple access, digital, AC power line communication system.

Another object of this invention is to provide a security system that incorporates a multiple access, digital, AC power line communication system.

Another object of this invention is to provide an analog connection set top box system that incorporates a multiple access, digital, AC power line communication system.

Another object of this invention is to provide a digital connection set top box system that incorporates a multiple access, digital, AC power line communication system.

Another object of this invention is to provide an industrial control system that incorporates a multiple access, digital, AC power line communication system.

Another object of this invention is to provide a home automation system that incorporates a multiple access, digital, AC power line communication system.

Another object of this invention is to provide a digital PBX system that incorporates a multiple access, digital, AC power line communication system.

Another object of this invention is to provide a digital telephony system that incorporates a multiple access, digital, AC power line communication system.

Another object of this invention is to provide an analog telephony system that incorporates a multiple access, digital, AC power line communication system.

These and other objects of this invention will be readily apparent to those of ordinary skill in the art upon review of the following drawings, detailed description and claims. In the preferred embodiment of this invention, the communication system of this invention makes use of a novel high rate modulator and a novel high rate demodulator in communication with the communication device of interest and the AC power line.

### BRIEF DESCRIPTION OF DRAWINGS

In order to show the manner that the above recited and other advantages and objects of the invention are obtained, a more particular description of the preferred embodiments of this invention, which is illustrated in the appended drawings, is described as follows. The reader should understand that the drawings depict only present preferred and best mode embodiments of the invention, and are not to be considered as limiting in scope. A brief description of the drawings is as follows:

FIG. 1 is a top-level system block diagram of the preferred communication system of this invention.

FIG. 2a is a waveform and timing diagram of the signal processor section of the preferred communication system of this invention.

FIG. 2b is a block diagram of the signal processor section of the preferred communication system of this invention.

FIG. 2c is a block diagram of a first embodiment of the equalizer of the preferred communication system of this invention.

FIG. 2d is a block diagram of a second alternative embodiment of an equalizer of the preferred communication system of this invention.

FIG. 2e is a slot diagram of the TDMA of the present frame of the communication channel of this invention.

FIG. 3a is a detailed schematic diagram of the filter and 4:1 down sampler section of the preferred signal processor of this invention.

FIG. 3b is a timing diagram of the present digital filter of this invention.

FIG. 3c is a frequency response diagram of the present digital filter of this invention.

FIG. 4a is a block diagram of the phase shifter section of the preferred signal processor of this invention.

FIG. 4b is a detailed functional block diagram of the present phase shifter of this invention.

FIG. 5a is a detailed schematic of the first stage of the preferred phase shifter of this invention.

FIG. 5b is a detailed schematic of the second stage of the preferred phase shifter of the invention.

FIG. 5c is the first section of a hardware design listing of the preferred digital phase shifter of the invention.

FIG. 5d is the second section of a hardware design listing of the preferred digital phase shifter of the invention.

FIG. 5e is the third section of a hardware design listing of the preferred digital phase shifter of the invention.

FIG. 5f is the fourth section of a hardware design listing of the preferred digital phase shifter of the invention.

FIG. 5g is the fifth section of a hardware design listing of the preferred digital phase shifter of the invention.

FIG. 5h is the sixth section of a hardware design listing of the preferred digital phase shifter of the invention.

FIG. 6a is a detailed schematic diagram of the preferred sync processor of the preferred signal processor of this invention.

FIG. 6b is a detailed block diagram of the present receive phase generator of this invention.

FIG. 6c is a detailed schematic diagram of the present receive phase generator of this invention.

FIG. 7 is a detailed block diagram of the present AGC circuitry of this invention.

FIG. 8a is a detailed block diagram of the present embodiment of the CRC circuitry.

FIGS. 8b and 8c are timing diagrams of the present embodiment of the CRC circuitry.

FIG. 9 is a system block diagram of a telephony system incorporating the communication system of this invention.

FIG. 10 is a system block diagram of a digital telephony system incorporating the communication system of this invention.

FIG. 11 is a system block diagram of a digital PBX system incorporating the communication system of this invention.

FIG. 12 is a system block diagram of a home automation system incorporating the communication system of this invention.

FIG. 13 is a system block diagram of an industrial control system incorporating the communication system of this invention.

FIG. 14 is a system block diagram of a set top box having a digital connection incorporating the communication system of this invention.

FIG. 15 is a system block diagram of a set top box having an analog connection incorporating the communication system of this invention.

FIG. 16 is a system block diagram of a security system incorporating the communication system of this invention.

FIG. 17 is a system block diagram of a camera security system incorporating the communication system of this invention.

FIG. 18 is a system block diagram of a Bridge-RF system incorporating the communication system of this invention.

FIG. 19 is a system block diagram of a home theater system incorporating the communication system of this invention.

FIG. 20 is a system block diagram of a home audio system incorporating the communication system of this invention.

FIG. 21 is a system block diagram of a digital audio distribution system incorporating the communication system of this invention.

FIG. 22 is a system block diagram of an intercom system incorporating the communication system of this invention.

FIG. 23 is a system block diagram of an Internet distribution system incorporating the communication system of this invention.

FIG. 24 is a system block diagram of an embedded modem system incorporating the communication system of this invention.

FIG. 25 is a system block diagram of a telephony/analog/PBX system incorporating the communication system of this invention.

FIG. 26 is a system block diagram of a home networking system incorporating the communication system of this invention.

FIG. 27 is a system block diagram of an automobile sensor system incorporating the communication system of this invention.

FIG. 28 is a system block diagram of an automobile control system incorporating the communication system of this invention.

FIG. 29 is a system block diagram of an automobile navigation system incorporating the communication system of this invention.

FIG. 30 is a first system block diagram of a truck sensor system incorporating the communication system of this invention.

FIG. 31 is a second system block diagram of a truck sensor system incorporating the communication system of this invention.

FIG. 32 is a system block diagram of a shop communications system incorporating the communication system of this invention.

Reference will now be made in detail to the present preferred embodiment of the invention, examples of which are illustrated in the accompanying drawings.

### DETAILED DESCRIPTION

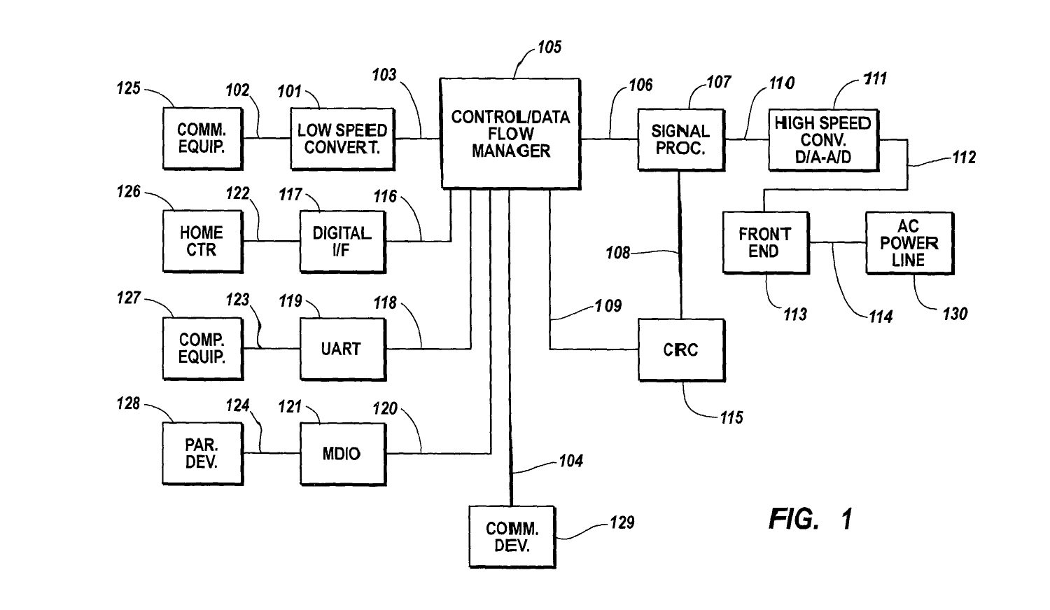

FIG. 1 is a top-level system block diagram of the preferred communication system of this invention. Low speed converters 101 are provided to communicate 102 with communication equipment 125. Typical communication equipment 125 includes but is not necessarily limited to telephones, modems, facsimile machines, computers, audio/video equipment and the like. The preferred low speed converters 101 are digital-to-analog and analog-to-digital converters having sample rates in the range of 44 kHz to 96 kHz. The communication channel 102 between the low speed converters 101 and the communication equipment 125 is typically, although not exclusively, one or more analog channels. The low speed converters 101 are in digital communication 103 with a controller/data flow manager 105. The preferred controller/data flow manager 105 is a programmable microprocessor, typically although not exclusively a TDM type microprocessor having a media access controller (MAC), and multiplexer with sequencing peripherals, which provides direct control of the system and particularly of the data flow to and from the communication channel of this invention. This controller/data flow manager 105 also includes the standard components common to microprocessors, including but not necessarily limited to a clock generator, dynamic memory (DRAM), read-only memory (ROM), and interfaces to peripherals. Converter bypass channels 104 provide a digital connection between the controller/data flow manager 105 with one or more communication devices 129. The controller/data flow manager 105 is in digital communication 106 with a signal processor 107. The preferred signal processor 107 of this invention is an Orthogonal Frequency Division Multiplexing (OFDM) type processor adapted with a hardware physical layer protocol specifically for communication over the AC power line channel. Although, in alternative embodiments of this invention the communication channel may be dedicated wiring or RF over-the-air communications. Additional detail on the preferred signal processor 107 of this invention is described below and shown in subsequent figures. The signal processor 107 is a connected 110 to one or more high-speed converters 111 for the AC power line, or alternatively dedicated or RF over-the-air channel, connection. The preferred high-speed converters 111 are 8-bit digital-to-analog/analog-to-digital converters with sample rates between 2 M samples per second and 20 M samples per second. The present preferred sample rate is 11.2 M samples per second. Connected 112, in the AC power line embodiment shown here, to the high speed converters 111 is the AC power line front end 113, which provides a standard power line connection 114 to the AC power line 130, and which typically includes one or more amplifiers, couplers, and an adjustable gain controller. Also connected 16 to the controller/data flow manager 105 is a digital interface circuit 117 which provides an interface 122 to one or more digital devices, such as home control devices 126. Also connected 118 to the controller/data flow manager 105 is a UART device 119 to provide a general purpose serial connection 123, such as an RS-232 serial port, to standard computer equipment 127 for such tasks as programming, diagnostics, up-dating and monitoring of the communication system of this invention. The controller/data flow manager 105 is also provided with a connection 120 to a MDIO device 121 that provides a general purpose parallel port connection 124 to other controllers 128 as desired. A Cyclic Redundancy Check (CRC) circuit 115 is provided in electronic communication 109 and 108 with the controller/data flow manager 105 and the signal processor 107 for the detection of errors during communications using multiple Cyclic Redundancy Checking Codes.

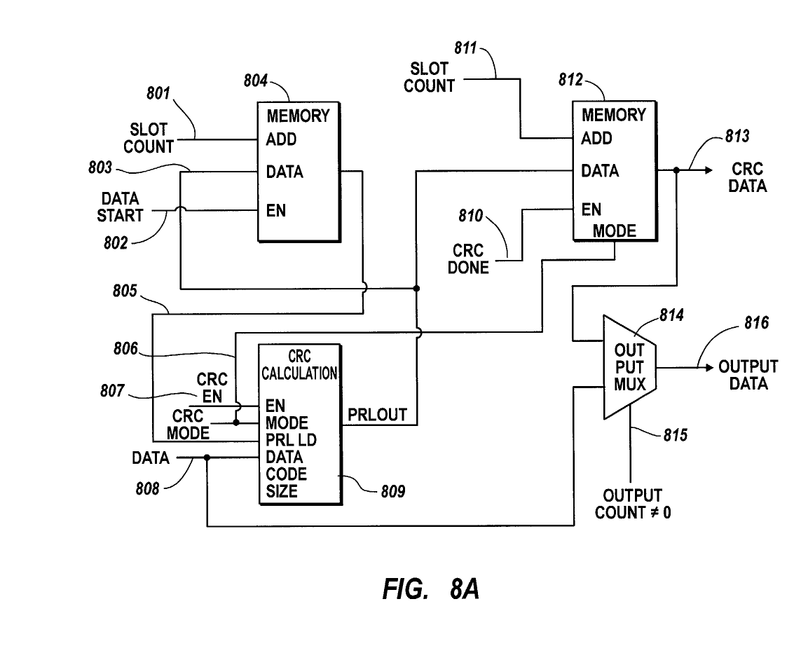

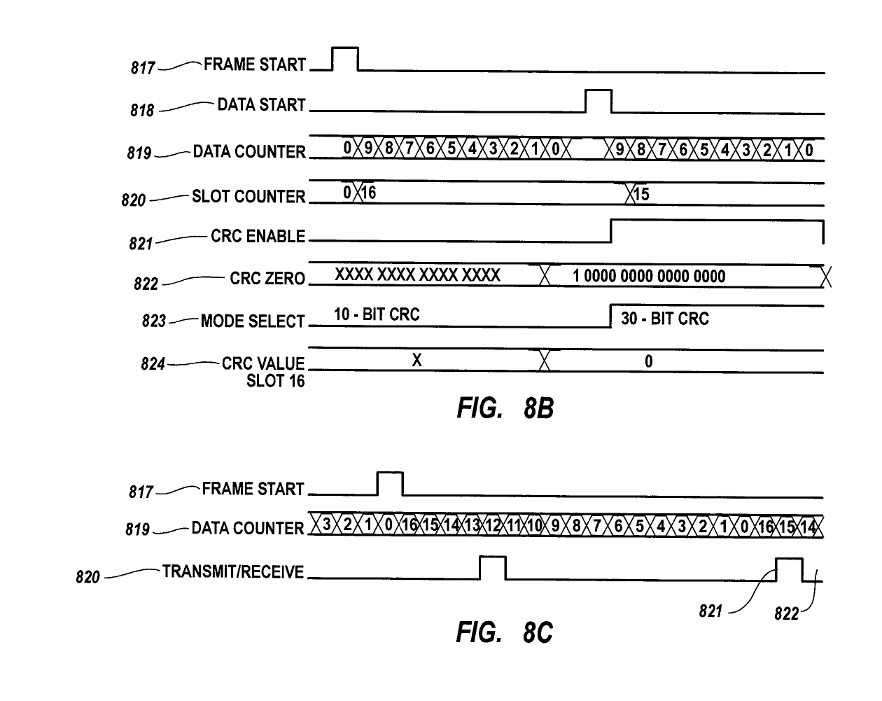

The present embodiment of the CRC takes advantage of the properties of time division multiple access (TDMA) communication to independently calculate the CRC value for each time slot. In addition, this CRC circuit has the ability to adjust the size of the CRC code to optimize throughput. Although systems generally use the same CRC size for all communications, some messages are short and therefore a shorter CRC code can be used, which reduces transmission and processing overhead. An example of a short message is an acknowledgement packet. An acknowledgement packet is transmitted after a data packet is received. This allows the receiver to know the packet was received. Acknowledgement packets are generally very small. Therefore, adding a large CRC to the end of the packet lowers throughput tremendously, without a large improvement in overall performance. In an optimized system, one CRC code should be utilized for larger packets and a smaller CRC code should be used for smaller packets. This new CRC circuit design allows multiple CRC codes to be used, and it is designed to be used in a system with many time divisions, such as TDMA. Additional detail on the functionality of this CRC circuit is provided below with respect to FIGS. 8a-c.

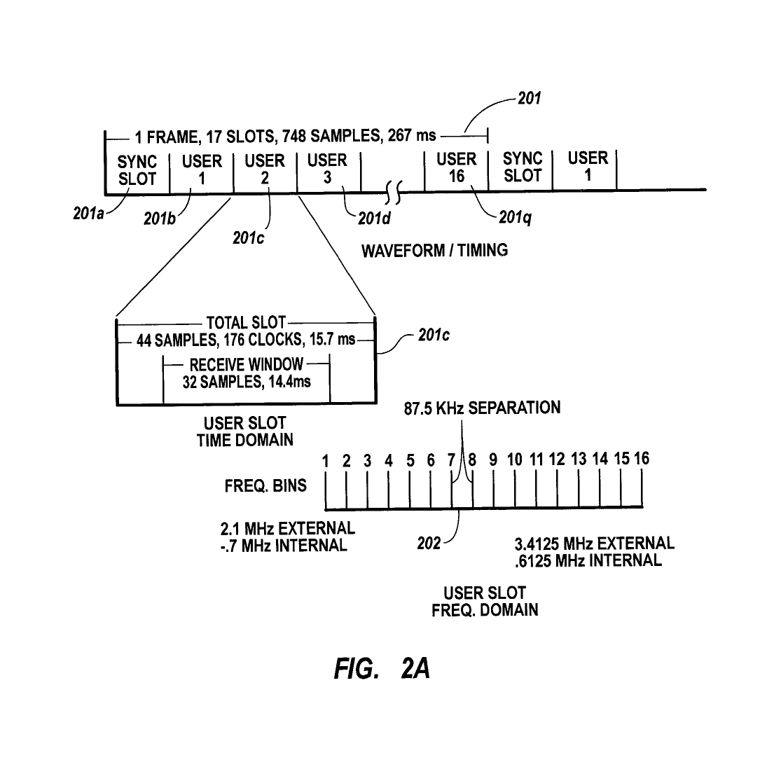

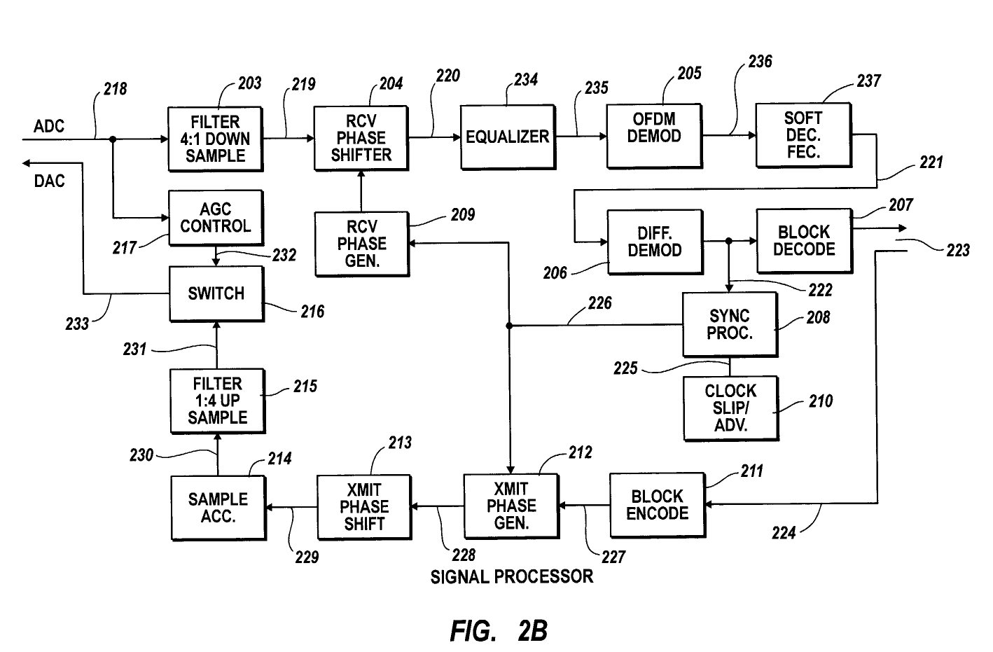

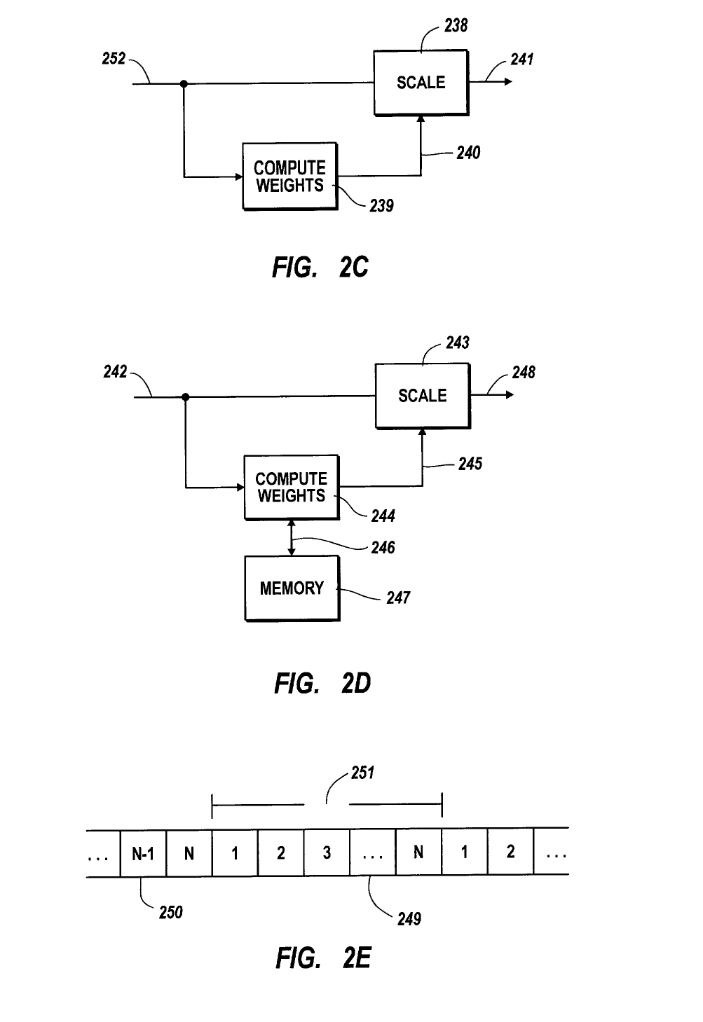

FIG. 2a is a representation of a typical waveform and timing that is associated with the communication system of this invention. This timing and waveform is provided to describe the present embodiment of this invention, in potential and envisioned future embodiments, alternative timing and waveforms may be used without departing from the concept of this invention. A frame 201 is typically 267 microseconds in length and consists of 17 15.7 microsecond time slots 201a-q. The first slot 201a is a sync slot used by a master terminal to establish a network time base. The remainder of the slots 201b-q are arbitrarily assigned to users of the network for use in data transmission. The data transmission consists of 16 OFDM tones 202 evenly spaced between 2.1 MHz and 3.4125 MHz in 87.5 kHz intervals. The sync slot transmission has a known initial phase on each tone. This known initial phase for each tone has a profile that can be preset to define a network and/or association with other modes. The user data slot information is carried in the frame-to-frame phase shift of each of these 16 tones. These phase shifts are established from 10 data bits using a block encoder, described further in this specification. The receiver operates on a central 11.4 microseconds of the 15.7 microsecond slot to avoid intersymbol interference and to minimize interference between tones. The present timing is shown in this FIG. 2a and is described as follows. The smallest fundamental unit of time for this system is the system clock with operates at 44.8 MHz. The digital signal processing is clocked at this rate. The system clock is further divided by 4 to produce the 11.2 MHz analog interface clock. This interface clock controls the digital to analog converter transmitter output and the analog to digital converter receiver input rates. The analog interface clock is further divided by 4 to produce the 2.8 MHz sample rate clock. This clock controls the rate at which samples are processed internally. Any subsequent reference to samples is at this rate. The OFDM frequency bins are separated by 1/32 of the sample rate. The sample clock is divided by 44 to produce the data slot rate. Symbol strobes, subsequently referred to, occur at this rate. Symbol strobes are nominally divided by 17 to produce the frame strobe. The exact time of occurrence of the frame strobe differs from the above timing relationship by a number of system clocks in order to synchronize the slave users to the master.

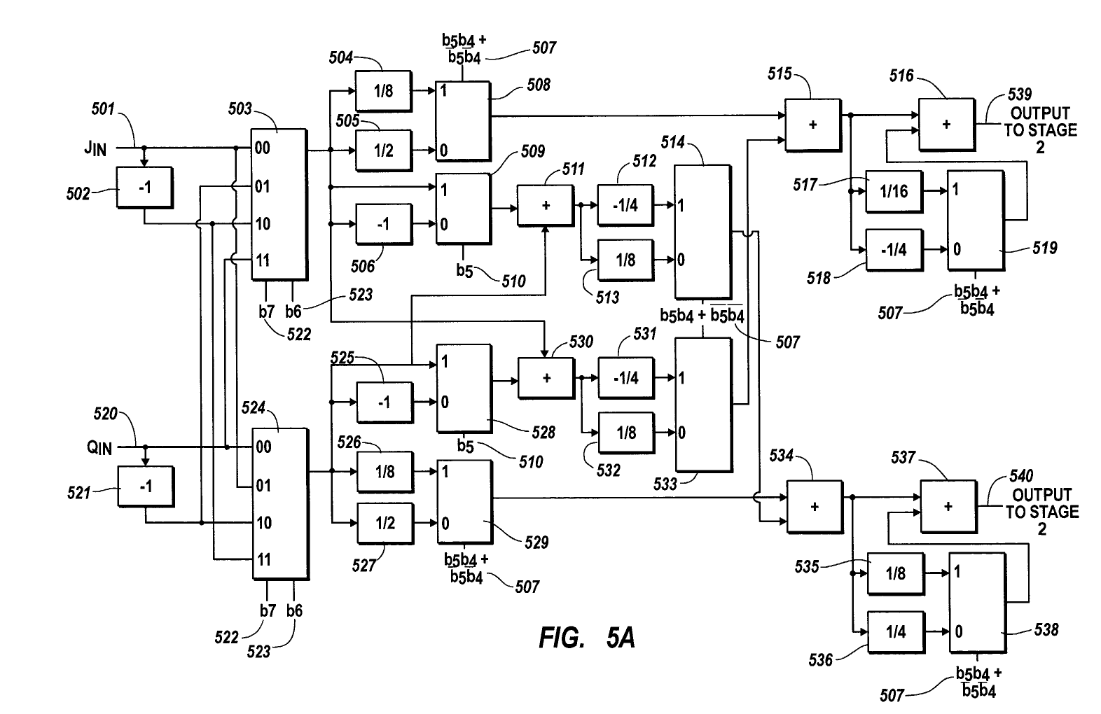

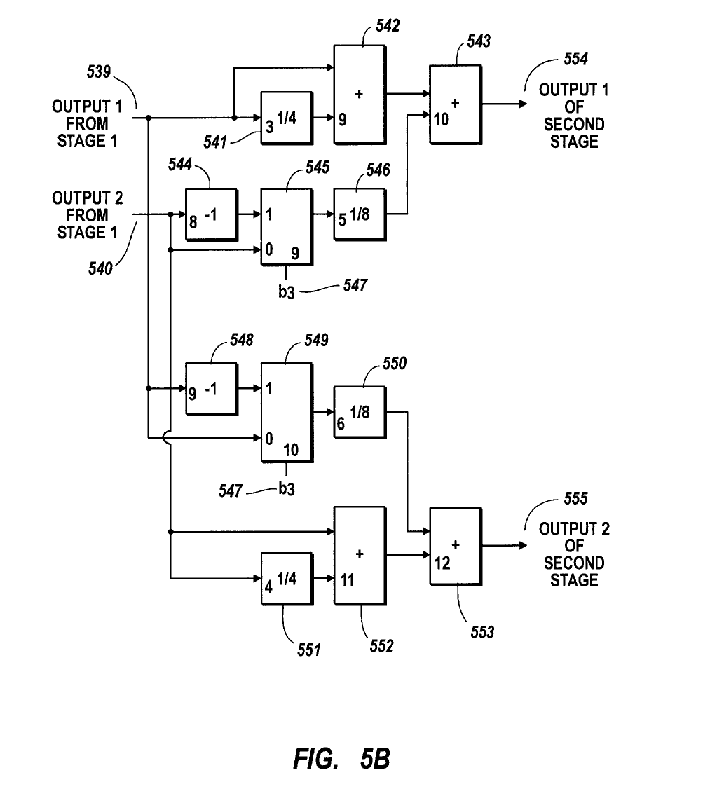

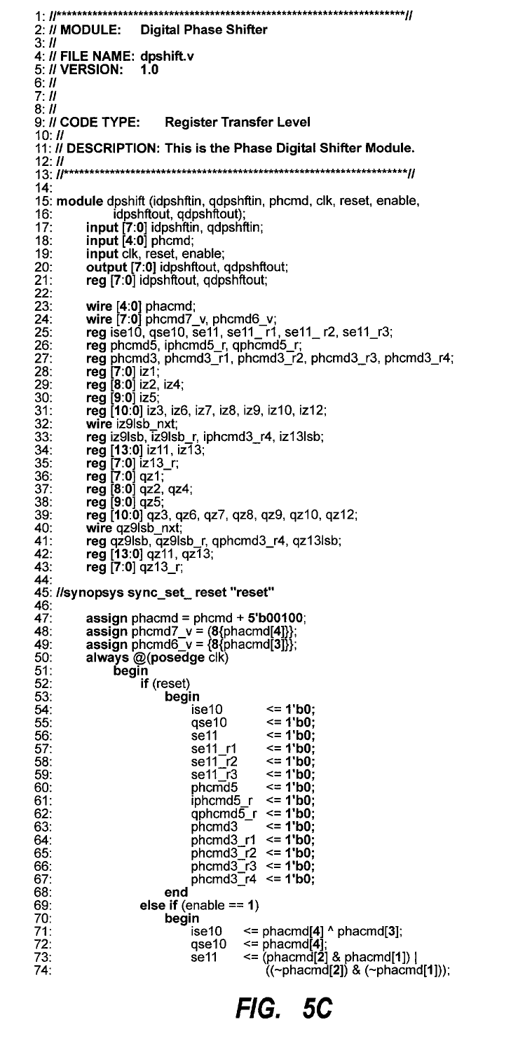

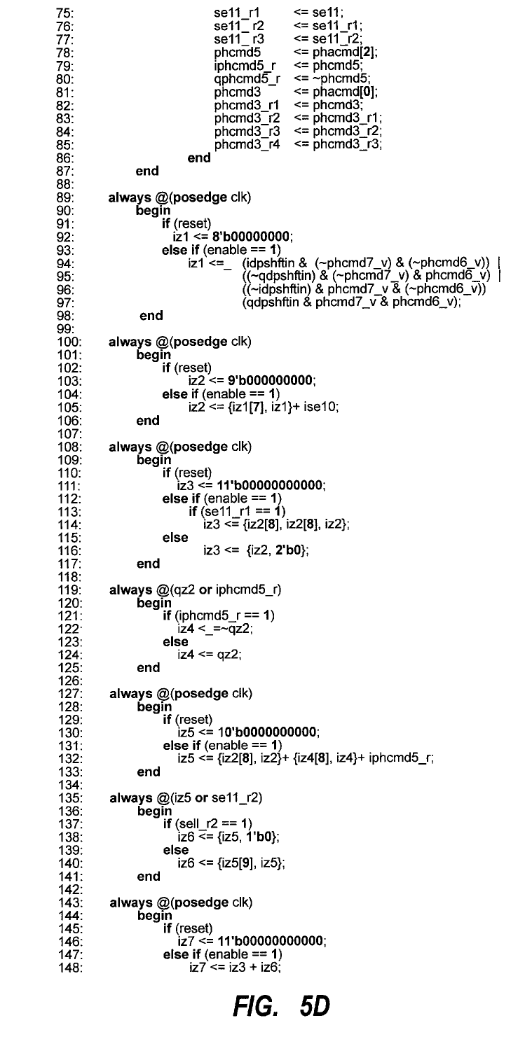

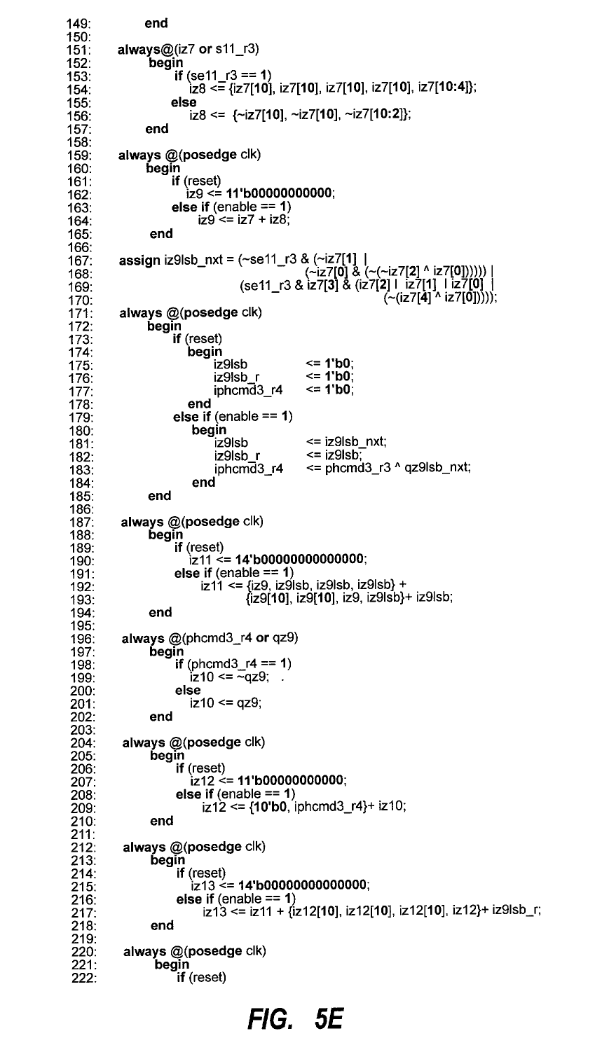

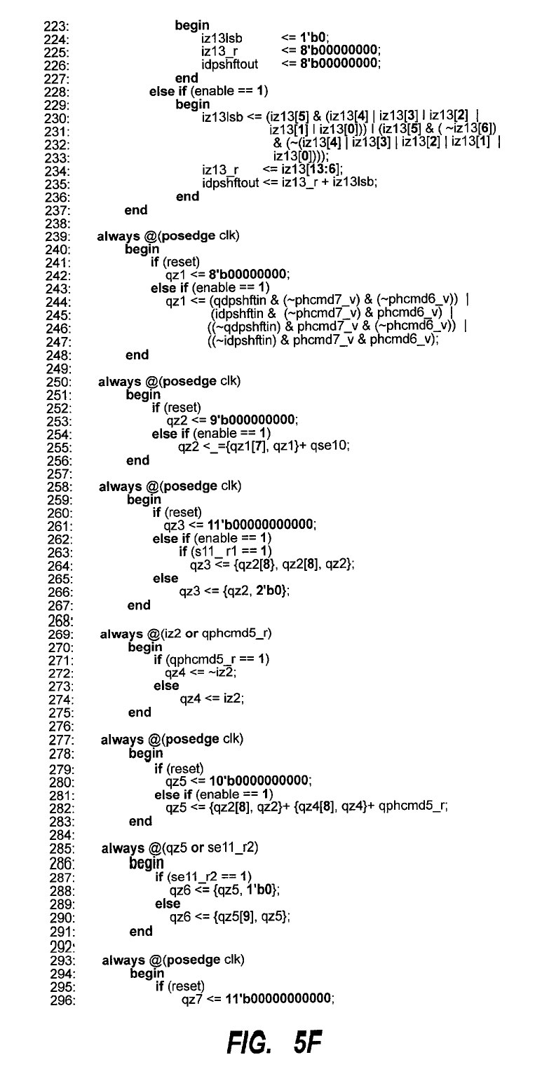

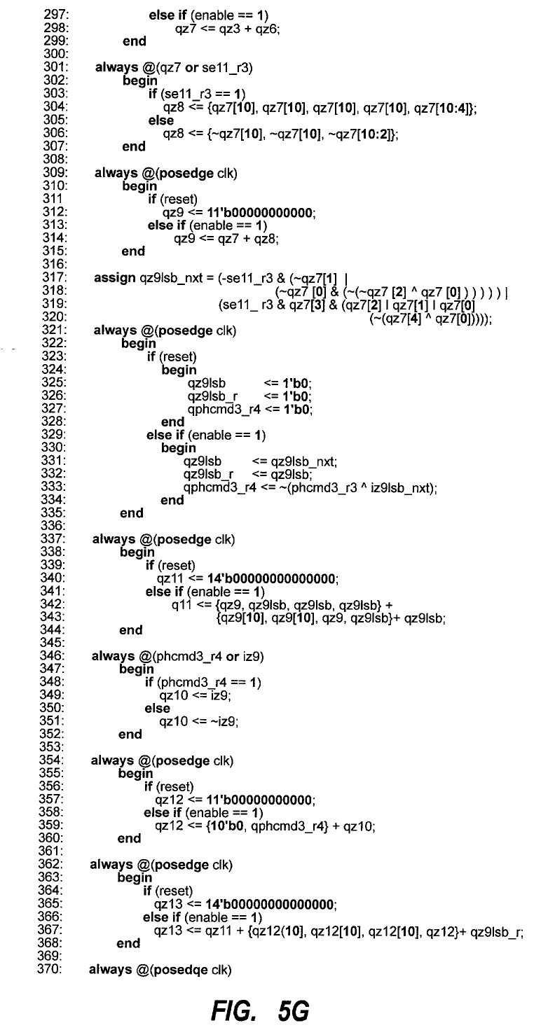

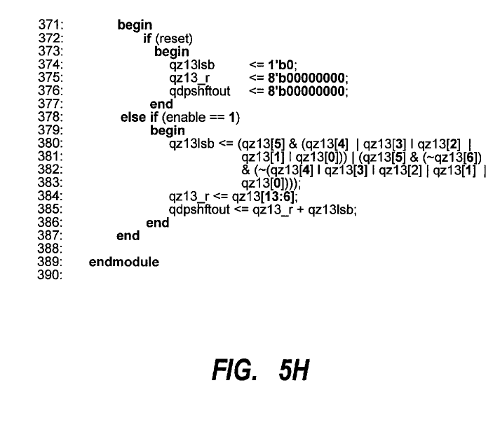

FIG. 2b is a block diagram of the signal processor section 107 of the preferred communication system of this invention. A filter and 4:1 downsampler 203 is provided to filter the analog to digital rate input 218 and to downsample it to the sample rate. The filter and 4:1 downsampler 203 also translates the waveform from real data from 2.1 MHz to 3.4124 MHz to complex data from −0.7 to 0.6125 MHz. Receiving the filtered and downsampled signal 219 from the filter and 4:1 downsampler 203 is a receiver phase shifter 204. The present embodiment of the receiver phase shifter 204 multiplies the complex input by a nearly constant gain and rotates it by an integer multiple of 11.25 degrees plus 5.625 degrees in response to a 5 bit phase command. This embodiment of the receiver phase shifter 204 is capable of performing 1 phase shift per system clock. This receiver phase shifter 204 is further described in additional detail below and on FIGS. 5a-h. An equalizer 234 received the phase shifted signal 220 from the receiver phase shifter 204. The preferred equalizer 234 is further described below and in FIGS. 2c and 2d. An OFDM (Orthogonal Frequency Division Multiplexing) demodulator 205 receives the equalized signal 235, containing weighted tones, from the equalizer 234. The OFDM demodulator 205, which multiplies the equalizer 234 output 235 for each of the 16 frequency bins by the complex conjugate of a stored value and accumulates the phase shifter samples for each of the 16 frequency bins and, after accumulation, automatically scales all results by the appropriate power of two to prevent overflow while reducing the required number of bits to represent each of the 16 frequency bins. The stored value, during the sync slot or acquisition time, is the next lower frequency bin. During data slot times the stored value is the OFDM demodulator 205 output 236 for the same frequency bin in the previous frame. Continuous Wave (CW) interference may be reduced, in some embodiments, by zeroing any bins above a preset threshold. Receiving demodulated data 236 from the OFDM demodulator 205 is a soft decision forward error corrector 237 which performs error correction and outputs hard decision bits 221 to a differential demodulator 206. The differential demodulator 206 makes use of the 704 system clocks in a symbol time to sequentially perform each of the 16 multiples using a sequential shift and accumulate. A block decoder 207 receives the output 222 of the differential demodulator 206 and sequentially correlates the 16 differential demodulation outputs with 32 stored length 16 block codes. The code which produces the largest real value is specifies five bits, while the code which produces the largest imaginary value specifies another five bits. Therefore, a five bit real-value and a five-bit imaginary-value is specified by the present embodiment of the code. In the current embodiment of the invention the 32 provided codes are a permutation of the length 16 Walsh codes and their inversions. The block decode 207 provides an output 223 which is received by the controller/data flow manager 105. The output 222 of the differential demodulator 206 is also received by the sync processor 208. The sync processor 208 processes the sync symbol and is used to acquire and track the sync transmitter. In the present embodiment of the invention, the sync processor 208 generates commands to advance or retard local timing by an integer number of system clocks (44.8 MHz) each frame, either for searching or tracking purposes. The sync processor 208 also generates a phase compensation value used to adjust transmit and receive phases to accommodate timing errors. The sync processor 208 is disabled in the master terminal. The sync processor 208 provides a first output 225 to the clock slip/advance circuit 210. The clock slip/advance 210 is provided to advance the start of a frame by up to four system clocks or retard the start of a frame by up to a full frame, upon command, in order to expedite search and tracking. Clock slip/advance is also disabled in the master terminal. The sync processor 208 also provides a phase compensation output 226 which is received by the receive phase generator 209 and the transmit phase generator 212. The receive phase generator 209 produces the phase commands to demodulate each frequency bin on each sample. The receive phase generator 209 also calculates a compensating phase for each frequency bin given the phase compensation input. The receive phase generator 209 produces a phase dither to reduce the effect of errors from the granularity of the receive digital phase shifter 204. During sync symbols, the receive phase generator 204 removes the phase of the sync pattern.

Receiving data 224 from the control/data flow manager 105, the block encoder 211 uses five input bits to specify one of 32 stored codes of length 16, typically chosen from a table. These five bits become the real components of each of the 16 frequency bins. Another five bits similarly specify the imaginary part of each of the frequency bins. Receiving the output 227 of the block encoder 211 is the transmit phase generator 212, which accepts the 16 one bit real and imaginary values from the block encoder 211 and converts them to a 45, 135, −135 or −45 degree differential phase command. These differential phase commands are added to the phase commands from the same bin of the same slot of the previous frame to form the new phase command. This new phase command is phase compensated and dithered similarly to that of the receive phase generator 209. If the terminal is designated as the master terminal, the sync phases are commanded during sync time. The output 228 of the transmit phase generator 212 is received by the transmit phase shifter 213. The transmit phase shifter 213 operates the same as the receiver phase shifter 204, described above. The complex value input is held to be a constant in the current embodiment of the invention, but in alternative embodiments could be used to independently control the magnitude of each frequency bin. Alternatively, a 32 element RAM can be used for constant magnitudes. The sample accumulator 214 receives the result 229 of the transmit phase shifter 213 and accumulates the phase shifter values from each frequency bin for each sample and outputs a signal 230 for receipt by the filter and 1:4 upsampler 215. The filter and 1:4 upsampler 215 performs the same filtering as the downsampler 203. The two FIR stages are essentially identical to the same stages as the downsampler 203 but are connected to perform an upsample, frequency translation and real part function to produce a DAC input. The output 231 of the filter and 1:4 upsampler 215 is provided to a switch 216, the other input 232 of which is received from the AGC controller 217. The switch 216 allows the DAC output to be the transmitted waveform during transmit time slots and the gain command, from the AGC controller 217 during the receive time slots. The output 233 of the switch 216 is provided to the DAC. The DAC and ADC are provided in the High Speed Converter (D/A-A/D). The AGC controller 217 monitors the analog to digital converter output and issues gain commands to keep this value in a desirable range. It has a separate command for each receive slot. It adjusts the gain for each user burst based on the history of its time slot. The gain level is commanded to the burst before the first sample for that particular slot is taken. During the time the samples are taken the gain is adjusted in a first order closed loop, which keeps the average absolute value of the input at a fixed level. On the symbol strobe the final gain is returned to a FIFO and replaced with the initial gain for the next slot.

FIG. 2c shows a first equalizer that functions by weighting 239 each received OFDM tone 252 by computing the energy in each tone over a single frame or, alternatively, over multiple frames. After the energy in each tone is determined, a weight is computed for each tone and then each tone is scaled 238 by the computed weight 240. Thereby, producing weighted tones 241.

FIG. 2d shows an alternative equalizer that receives OFDM tones 242, computes the weights 244 and scales 248 the OFDM tones 242 by the computed weights 245. In this embodiment, the computed weights are stored, if greater than a threshold value, in memory 247 for each TDMA slot.

FIG. 2e shows the frame/slot relationship 249 of the TDMA frame 251, showing a number of slots 250.

The purpose of the equalizer is to condition the signal for processing through the soft decision FEC decoder 237. Proper weighting of the tones results in a relative increase in the energy of tones with higher signal-to-noise ration compared to those with lower signal-to-noise ratio. Since the FEC decoder 237 uses a soft decision, this weighting of the tones results in an FEC with a smaller probability of bit error compared with a system without the equalizer. In the present preferred embodiment of this invention, the equalizing function is implemented such that a different equalization function is computed for each slot 250 of the frame 251. This is done so that the receiver will be capable of equalization for different channels that exist for different slots arising from reception of the signal from multiple devices due to TDMA. The weights may depend on samples in the current TDMA frame and previous TDMA frames, but not upon samples from other TDMA slots in the current TDMA frame or samples from other slots in previous TDMA frames, where a TDMA frame consists of multiple slots that may be assigned to different nodes.

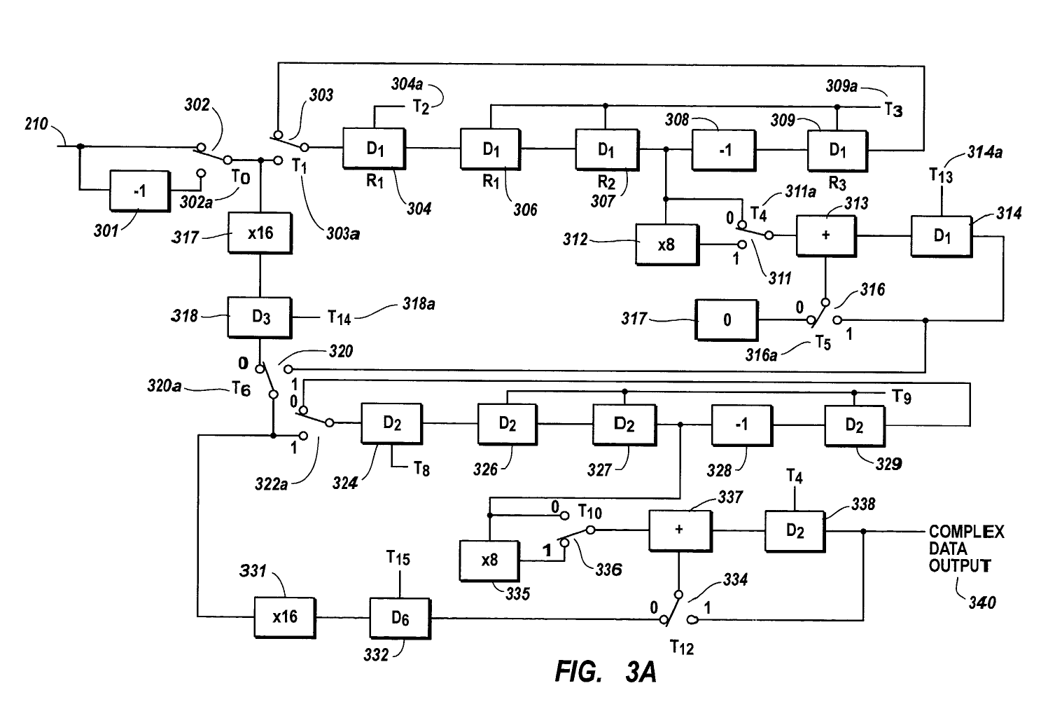

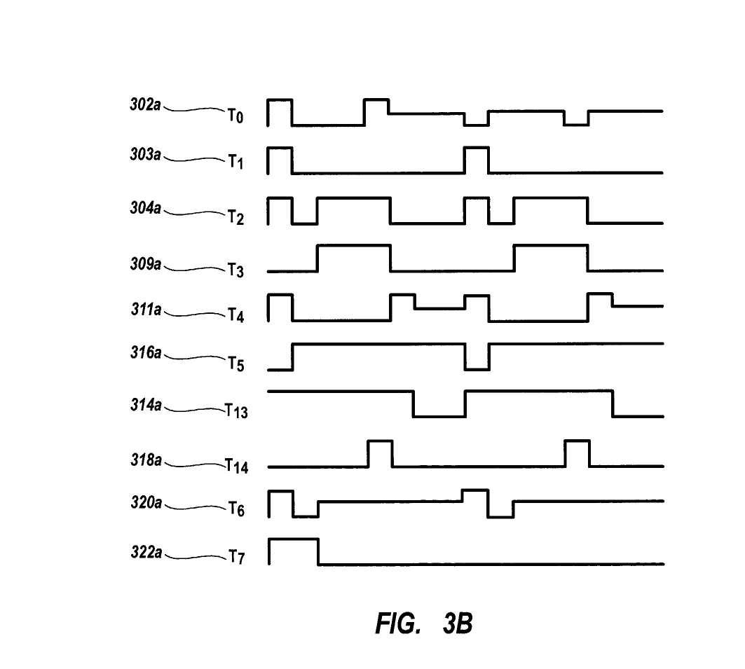

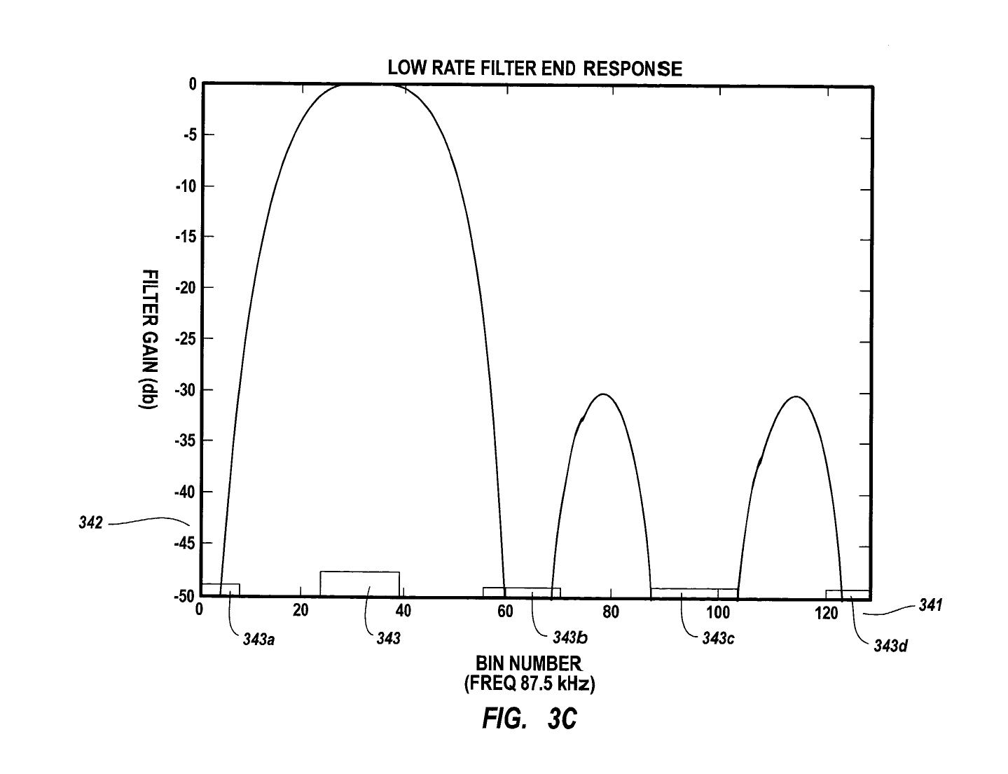

FIG. 3a is a detailed schematic diagram of the filter and 4:1 downsampler 203 section of the preferred signal processor of this invention. This circuit provides a 4:1 downsampled FIR with an impulse response of j 0 9j 16−18j 0−66j−144 216j 256−216j−144 66j 018j 16−9j 0−j. The input is first downconverted by ¼ the ADC rate by multiplying the successive real samples by 1, j, −1 and −j. This downconverted signal is then passed through a FIR with an impulse response of −1 0 9 16 9 0 −1, which forms an acceptably good half band filter. This half band filter is 2:1 downsampled at the time that the imaginary input is on the 16-center tap and the two zero taps and the real inputs are on the other four taps. These complex downsamples are halfband filtered with an identical filter and the results are again downsampled. Because the 2nd filter is operating at half the rate of the first filter, the real and imaginary inputs can be successively processed and the results can be combined at the 2nd downsample time. This filter and 4:1 downsampler 203 emphasizes an efficient digital design. The input signal 210, is provided to a first negative 1 multiplier 301 and to a first input to a first switch 302. The output of the first negative 1 multiplier 301 is connected to the second input of the first switch 302. The output of the first switch 302 is connected to a first times 16 multiplier 317 and a first input of the second switch 303. The second input of the second switch 303 is provide by the output of a fourth delay 309. The output of the second switch 303 is received by a first 1-clock delay 304. The output of the first 1 clock delay 304 is received as the input of a second 1-clock delay 306. The output of the second 1-clock delay 306 is received by a third 1-clock delay 307. The output of the third 1-clock delay 307 is received by a second negative 1 multiplier 308, a first times 8 multiplier 312 and the first input to a third switch 311. The output of the second negative 1 multiplier 308 is received as the input to the fourth 1-clock delay 309. The output of the first times 8 multiplier 312 is connected to the second input to the third switch 311. The output of the third switch is received as the first input to a first summer 313. The output of the first summer 313 is received as the input to the fifth 1-clock delay 314. The output of the fifth 1-clock delay 314 is connected to a first input of a fourth switch 316 as well as to the first input of a fifth switch 320. The other input of the fourth switch 316 is connected to a zero 317. The output of the fourth switch 316 is the second input of the first summer 313. The output of the first times 16 multiplier 317 is the input of a 3-clock delay 318. The output of the 3-clock delay 318 is connected to the second input of the fifth switch 320. The output of the fifth switch 320 is connected to a first input of a sixth switch 322 and a second times 16 multiplier 331. The output of the sixth switch 322 is connected to a first 2-clock delay 324 the output of which is connected to a second 2-clock delay 326. The output of the second 2-clock delay 326 is connected to the input of a third 2-clock delay 327. The output of the third 2-clock delay 327 is connected to the input of a third negative 1 multiplier 328, a second times 8 multiplier 335 and a first input of a seventh switch 336. The output of the third negative 1 multiplier 328 is connected to the input of a fourth 2-clock delay 329. The output of the fourth 2-clock delay 329 is connected to the second input of the sixth switch 322. The output of the second times 8 multiplier 335 is connected to the second input of the seventh switch 336. The output of the seventh switch 336 provides a first input to the second adder 337. The output of the second adder 337 is connected to the input of a fifth 2-clock delay 338. The output of the fifth 2-clock delay 338 provides the output 211 of the filter and 4:1 down sampler 202, as well as providing the input to an eighth switch 334, the output of which is the second input to the adder 337. The output of the second times 16 multiplier 331 is connected to the input of a 6-clock delay 332, the output of which is connected to the second input of the eight switch 334. Each switch 302, 311, 316, 320, 322, 336, 334 is controlled by the controller 115, via the control signals 109.

FIG. 3b is a present embodiment timing diagram of the time points shown in FIG. 3a, specifically T0 302a; T1 303a; T2 304a; T3 309a; T4 311a; T5 316a; T13 314a; T14 318a; T6 320a; and T7 322a. After each of these system clock times, a downsampled output is provided.

FIG. 3c is a frequency response curve for the present embodiment of the filter of FIG. 3a, showing bin numbering on the X-axis 341 and the filter gain on the Y-axis 342. Aliased bands of interest 343a-d are located at multiples of the 2.8 MHz sample rate from the desired band 343 shown.

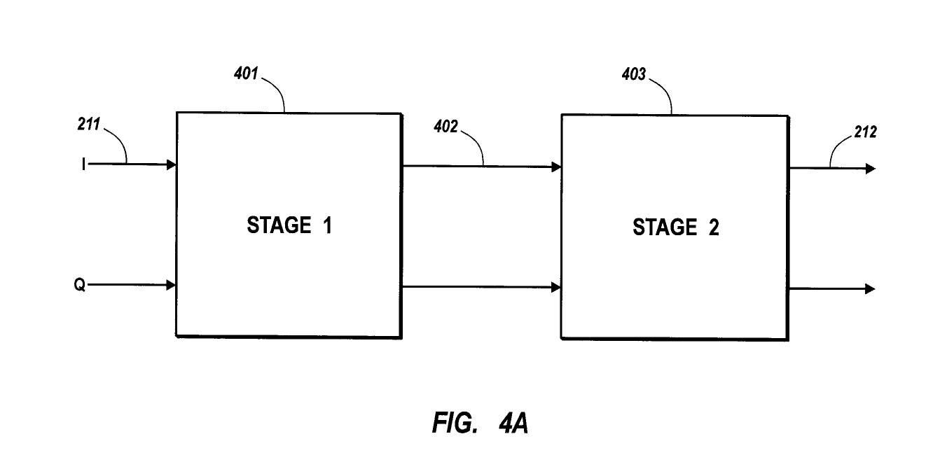

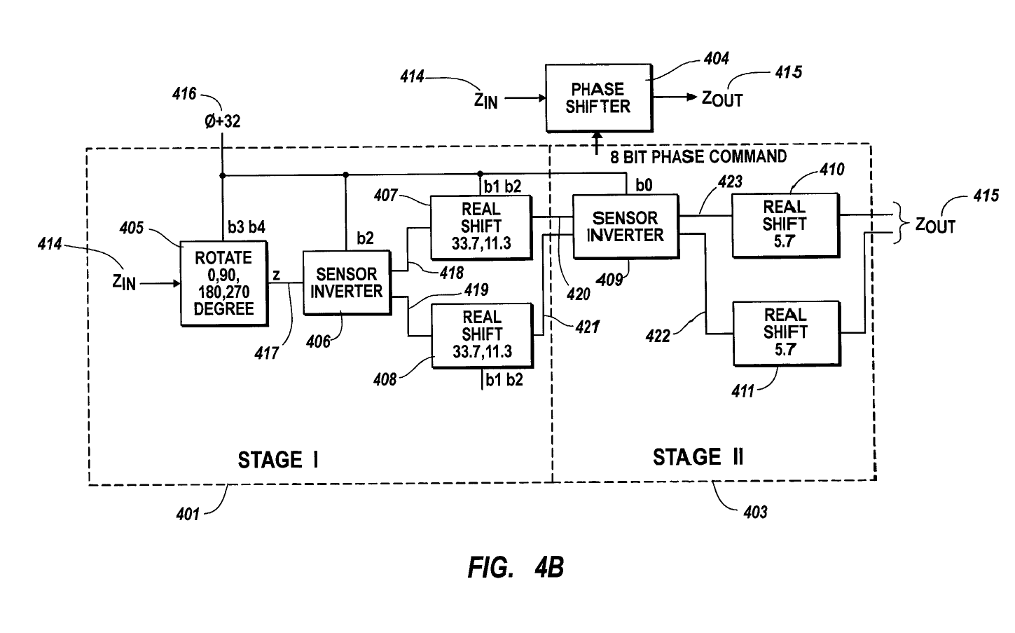

FIG. 4a is a block diagram of the phase shifter 204 section of the preferred signal processor 107 of this invention. The input 211 from the filter and 4:1 down sampler 202 is received by a first stage section 401, which is in electronic communication 402 with the second stage section 403. The output 212 of the second stage section 403 is provided to the summer 221 of FIG. 2b. In the present embodiment, the two most significant bits of the phase command select a multiple of 90 degrees of phase by appropriately selecting the real or imaginary parts or their inverses. The next two bits (1 and 2) select a rotation of plus or minus 33.7 or 11.3 degrees by appropriately combining I and Q or their inverse in the ratio of either 3-to-2 or 5-to-1 with a magnitude gain of 0.4788 or 0.4780. The least significant phase command bit (0) selects a further rotation of plus or minus 5.7 degrees by appropriately combining I and Q or their inverse in the ratio of 10:1.

FIG. 4b is a functional block diagram of the receiver digital phase shifter 204 and the transmitter phase shifter 213 of the present embodiment of this invention, which for the purpose of this drawing is referred to as the digital phase shifter 404. This digital phase shifter 404 is composed of two stages 401, 403. The digital phase shifter 404 input 414 is received by a phase rotator 405. Phase rotator 405 rotates the signal phase by zero, ninety, one-hundred-eighty, or two-hundred seventy degrees based on the selection of control signals b3b4 of control word 416. The output 417 of the phase rotator 405 is received by the sense inverter 406, which inverts the imaginary part of the input if b2 is zero 418 and it swaps the real and imaginary inputs and inverts the imaginary part if b1 for output 419. A first real shifter 407 receives the input 418 and provides the real part of a shift of either 33.7 or 11.3 degrees based on the control signals b1b2. A second real shifter 408 receives the input 419 and provides the real part of a shift of either 33.7 or 11.3 degrees based on the control signals b1b2. The outputs 420, 421 of the first real shifter 407 and the second real shifter 408 constitute the real and imaginary outputs from stage 1 401 and are received as the input to stage 2 403 by a second sense inverter 409 that performs identically to 406 based on control signal b0 and produces an output 423 and an output 422. The output 423 is received by a third real shifter 410 that shifts the signal 5.7 degrees and provides the real part of the real component of output Zout 415. The output 422 is received by fourth real shifter 411 that shifts the signal 5.7 degrees and provides the real part for the imaginary component of output Zout 415.

FIG. 5a is a detailed schematic of the first stage 401 of the preferred phase shifter 203 of this invention. The first input J_{IN} 501 is received by a fourth negative 1 multiplier 502 as well as the first input to a first 4-to-1 multiplexer 503 and the second input of a second 4-to-1 multiplexer 524. The output of the fourth negative 1 multiplier 502 is connected to the third input of the first 4-to-1 multiplexer 503 as well as to the fourth input of the second 4-to-1 multiplexer 524. The second input Q_{IN} is received by a sixth negative 1 multiplier 521 as well as the first input to the second 4-to-1 multiplexer 524 and the fourth input of the first 4-to-1 multiplexer. The output of the sixth negative 1 multiplier 521 is connected to the third input of the second 4-to-1 multiplexer 524, as well as to the second input of the first 4-to-1 multiplexer 503. The outputs of the first 503 and second 524 multiplexers are selected by control signals b₇ 522 and b₆ 523. The output of the first 4-to-1 multiplexer is connected to a first divide-by-8 divider 504, a first divide-by-2 divider 505, a fifth negative 1 multiplier 506 and a second input to a second 2-to-1 multiplexer 509, which is controlled by control signal b₅ 510. The output of the first divide-by-8 divider 504 is provided as the second input of the first 2-1 multiplexer 508. The control 507 for the first 508, third 514, fourth 519, sixth 529, seventh 533 and eighth 538 2-to-1 multiplexers is provided by control signals b₅ and b₄ combined in the following logic equation: b₅ and b₄+notb₅ and notb₄. The output of the second 2-to1 multiplexer 509 is provided as the input to the third summer 511, the output of which is provided as the inputs to a first divide-by-negative-4 divider 512 and a third divide-by-8 divider 513. The first input of the first 2-1 multiplexer 508 is provided by the output of the first divide-by-2 divider 505. The first input of the second 2-to-1 multiplexer 510 is provided by the output of the fifth negative 1 multiplier 506. The third summer 511 also has for its second input the output of the second 4-to-1 multiplexer. The output of the first divide-by-negative-4 divider 512 is the second input to a third 2-to-1 multiplexer 514. The first input to the third 2-to-1 multiplexer 514 is the output of the third divide-by-9 divider 513. The output of a seventh 2-to1 multiplexer 514 and the output of the first 2-to-1 multiplexer 508 are inputs to a fourth summer 515, the output of which is connected to the input of a fifth summer 516, a divide-by-16 divider 517 and a second divide-by-negative-4 divider 518. The output of the second divide-by-negative-4 divider 518 is connected to the first input of the fourth 2-to-1 multiplexer 519. The output of the divide-by-16 divider 517 is connected to the second input of the fourth 2-to-1 multiplexer 519. The output of the fourth 2-to-1 multiplexer 519 is connected to a second input of a fifth summer 516, the output 539 of which is the first output of stage 1 401 of phase shifter 203.

The output of the second 4-to1 multiplexer 524 is connected to the inputs of the seventh negative 1 multiplier 525, the second divide-by-8 divider 526 and the second divide-by-2 divider 527, as well as the second input of a fifth 2-to-1 multiplexer 528. The first input of the fifth 2-to-1 multiplexer 528 is provided by the output of the seventh negative 1 multiplier 525. The output of the fifth 2-to-1 multiplexer 528 is an input to the sixth summer 530, the other input of which is the output of the first 4-to-1 multiplexer 503. The fifth 2-to-1 multiplexer is controlled by selection control bₛ. The output of the sixth summer 530 is connected to the inputs of the second divide-by-negative-4 divider 531 and the third divide-by-8 divider 532. The output of the second divide-by-negative-4 divider 531 is connected to the second input of the seventh 2-to-1 multiplexer 533. The first input of the seventh 2-to-1 multiplexer 533 is provided by the output of the third divide-by-8 532. The second input of the seventh 2-to-1 multiplexer 533 is provided by the output of the second divide-by-negative-4 divider 531. The output of the third divide-by-8 divider 526 is connected to the second input of the sixth 2-to-1 multiplexer 529. The first input of the sixth 2-to-1 multiplexer 529 is provided by the output of the second divide-by-2 divider 527. The output of the sixth 2-to-1 multiplexer 529 is connected to a first input of a seventh summer 534. The second input of the seventh summer 534 is the output of the third 2-to-1 multiplexer 514. The output of the seventh summer 534 is connected to the inputs of a fourth divide-by-8 divider 535, a second divide-by-4 divider 536 and an eighth summer 537. The output of the fourth divide-by-8 divider 535 is received by the second input of the eighth 2-to-1 multiplexer 538. The first input of the eighth 2-to-1 multiplexer 538 is provided by the output of the second divide-by-4 divider 536. The output of the eighth 2-to-1 multiplexer 538 is connected to the second input of the eighth summer 538. The output 540 of the eighth summer 538 is the second output to stage 2 of the phase shifter 203.

FIG. 5b is a detailed schematic of the second stage 403 of the preferred phase shifter 203 of this invention. The first output 539 from stage 1401 is connected to ninth summer 542, a third divide-by-4 divider 541, a ninth negative 1 multiplier 548 and the first input to a tenth 2-to-1 multiplexer 549. The second output 540 from stage 1401 is connected to an eighth negative 1 multiplier 544, a first input to a ninth 2-to-1 multiplexer 545, an eleventh summer 552, and a fourth divide-by-4 divider 551. The output of the third divide-by-4 divider 541 is the second input to the ninth summer 542. The output of ninth summer 542 is provided as a first input to a tenth summer 543. The output of the eighth negative 1 multiplier 544 is provided as the second input to the ninth 2-to-1 multiplexer 545, the output of which is connected to a fifth divide-by-8 divider 546. The output of the fifth divide-by-8 divider 546 is the second input to the tenth summer 543, the output 554 of which is output 1 of the second stage 403 of the phase shifter 203. The output of the ninth negative 1 multiplier 548 is connected to the second input of the tenth 2-to-1 multiplexer 549, the output of which is connected to the input of the sixth divide-by-8 divider 550. The output of the fourth divide-by-4 divider 551 is connected to the second input of the eleventh summer 552, the output of which is connected to an input of the twelfth summer 553. The output of the sixth divide-by-8 divider 550 is connected to the other input of the twelfth summer 553, the output 555 of which is the second output of the second stage 403 of the phase shifter 203.

FIG. 5c is the first section of a hardware design listing of the preferred digital phase shifter 203, as implemented in Verilog.

FIG. 5d is the second section of a hardware design listing of the preferred digital phase shifter 203, as implemented in Verilog.

FIG. 5e is the third section of a hardware design listing of the preferred digital phase shifter 203, as implemented in Verilog.

FIG. 5f is the fourth section of a hardware design listing of the preferred digital phase shifter 203, as implemented in Verilog.

FIG. 5g is the fifth section of a hardware design listing of the preferred digital phase shifter 203, as implemented in Verilog.

FIG. 5h is the sixth section of a hardware design listing of the preferred digital phase shifter 203, as implemented in Verilog.

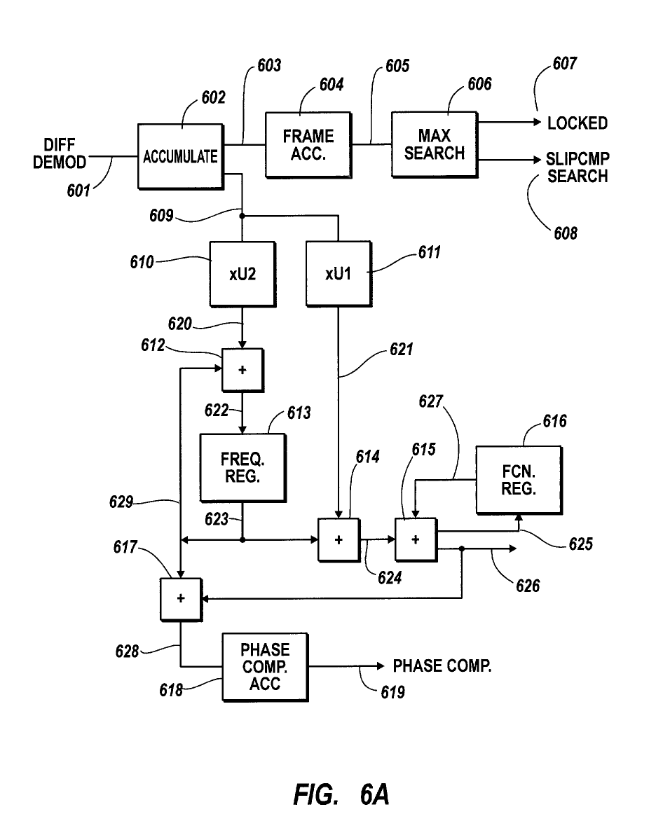

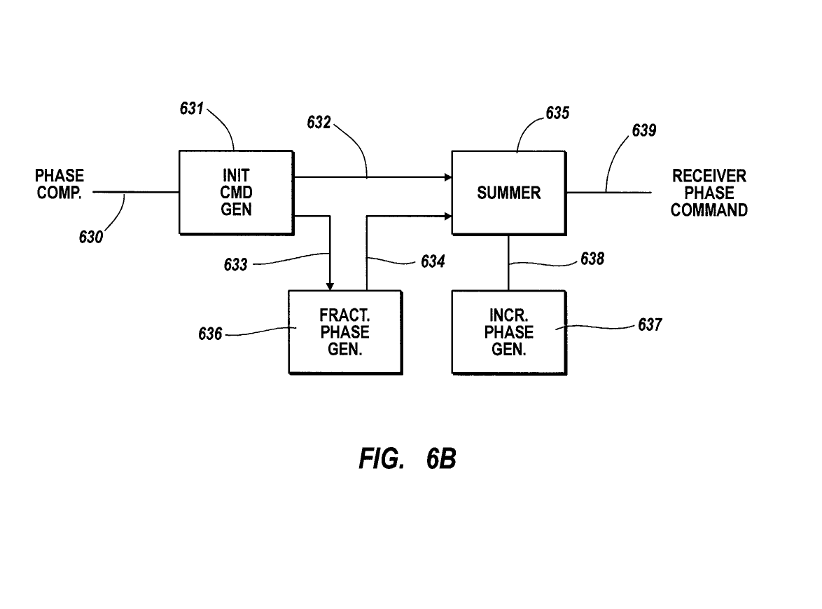

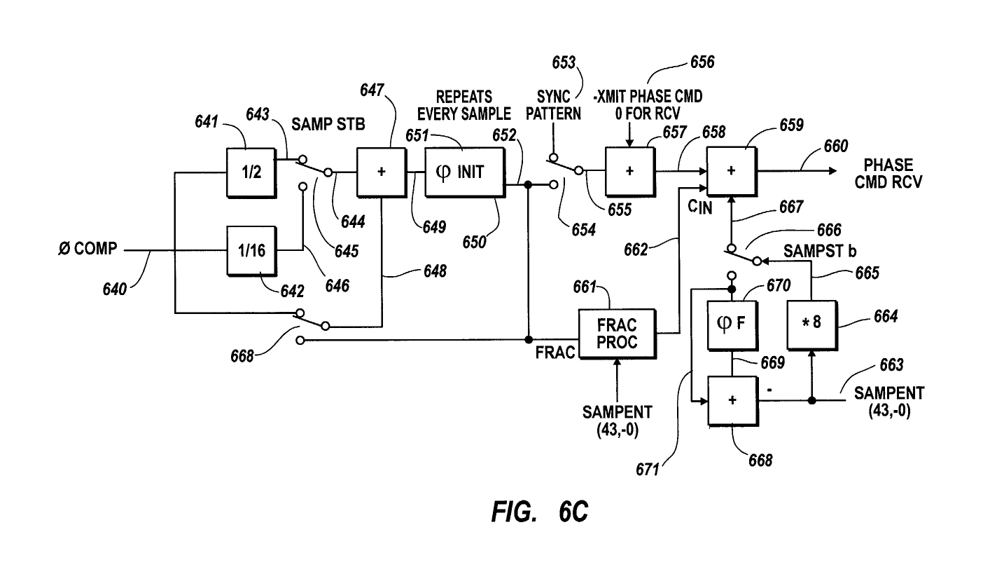

FIG. 6 is a detailed schematic diagram of the preferred sync processor 208 of the preferred signal processor 107 of this invention. The sync processor 208 of this invention receives the sync-processed inputs 601 (222 of FIG. 2b) from the differential demodulator 206. These inputs 601 consist of the 15 correlations of each bin with its immediate neighbor. The unique initial phase of each bin has been removed by the digital phase shifter 404. The phase of this correlation is the time error between the first sample and the time at which the initial phases apply, multiplied by the fixed frequency difference between bins. The 15 inputs per symbol are accumulated in accumulator 602. Near the lock point, the real part of the result is large and the imaginary part is proportional to time error. A search is performed on the real part 603 of the result. The input 603 to the frame accumulator 604 is accumulated by the frame accumulator 604 for each of the 17 slot times for a fixed number of frames. This multiple frame accumulation reduces the interference from non-sync channels and reduces noise, which have varying initial phases. After the accumulations are complete, the result 605 is provided to the maximum searcher 606. At the start of a search the maximum searcher 606 clears a maximum value register and sets a search slip register to zero. The maximum searcher 606 compares the accumulation input 605 from the frame accumulator 604 to the current maximum. If it exceeds the maximum, a new maximum along with the slot and slip count of the new maximum are stored. A slip command of 96 system clocks is then asserted and the slip counter is incremented. This process, of maximum searching, is repeated for 8 slip cycles, to cover an entire symbol and thus to search an entire frame for sync. At this point, if the maximum value exceeds a threshold, lock is declared, a final slip is computed from the slip counter and the slot number of the maximum value, and then tracking commences. Otherwise, the maximum search is restarted. Time tracking is done using the imaginary part 609 of the accumulated input once lock is declared and timing adjusted. These functions are typically only performed once per frame. The time error, imaginary part, 609 is fed into a type 2 tracking loop filter consisting of blocks 610, 611, 612, 613, 614. The filter operates by adding, in adder 614, the output 621 of a first multiplier 611 to the output 623 of a frequency register 613. The frequency register 613 stores the sum 623 of the output 620 of a second multiplier 610 and a previous value 629 of the frequency register 613, which are added in adder 612. The output of the filter 624 is a frequency command in system clocks per frame. This output 624 is added in adder 615 to the fractional part of a system clock 627, that has not yet been slipped, from the fractional register 616. The integer part 626 of this result becomes the compensating slip command for the current frame and fractional part 625 is stored in the fractional register 616 for the next frame. The frequency register 613 stores an estimate of how many system clocks of error between the terminal and the master terminal accumulate each frame. The number of system clocks of slip done 626 at the start of the frame is subtracted from the estimate 629 in adder 628. The result 628 is an estimate of how the number of system clocks of error between the master and the receiver changes during a frame. This result 628 is accumulated in the phase comparison accumulator 618 to provide a compensating phase command for data demodulation.

FIG. 6b shows the present embodiment of the receive phase generator 209. A receive phase shift command 639 is generated by summing, in summer 635, three different components 632, 634, 638. The input 634 from the fractional phase generator 636 can only be one or zero, so it uses the carry in input to the summer 635. The initial command generator 631 input 632 to the summer 635 is the initial phase command. This input 632 provides a different value for each frequency bin and repeats the same sequence for each sample of a slot. If the sync pattern is being processed, the sequence is the unique phase patter of the sync bins on the first sample at the desired lock point. For all data slots the sequence is a function of the phase compensation input 630. The phase compensation value is in units of system clocks. It is multiplied by each bin's frequency in phase shifter command units per system clock. In the current design, the phase shifter command is 32 per cycle. The 2.1 MHz lowest frequency bin is 3/64 of a cycle per clock. Successive frequencies increase at 87.5 kHz or 1/512 cycles per system clock. The sequence, therefore, starts with a value of 3/2 times the phase compensation number and increases by 1/16 the phase compensation number with each frequency bin. The integer part 632 of the initial phase is sent to the summer 635 and the fractional part 633 is sent to the fractional phase generator 636. The fractional phase generator 636 compensates the phase of each bin for the fractional part of the initial phase command. The digital phase shifter 404 has a granularity of 1/32 of a cycle or 11.25 degrees. If the integer part 632 only were used on every sample the differential phase could be in error by this amount on both the transmitter and the receive and, therefore, would produce unacceptable I/Q interference. This is avoided by picking the next larger phase command on a number of samples so that the average represents the fractional phase. The sample count is used for this process. If the fractional phase is greater than 0.5, then all even samples are incremented by 1, otherwise they are not. The odd samples are held at one until the desired average phase is achieved. This approach puts the phase compensation on a half sample rate bursted subcarrier, which reduces cross-interference with other OFDM frequencies. The incremental phase generator 637 produces phase increments 638 with each sample required for each frequency bin. The incremental phase generator 637 makes use of a sample count to accomplish this. The samples have been downconverted by the downsampler so that the lowest frequency in is at −¼ cycle per sample and increments by 1/32 cycle per sample. In phase command units the phase for the initial frequency bit is −8 times the sample count. The phase is incremented by the sample count for each successive bin. The sample count is then incremented for the next sample.

FIG. 6c is a detailed schematic diagram of the receive phase generator 209. The phase compensation signal 640 is received by a ½ multiplier 641, a 1/16 multiplier 642, and a first switch 668. The output 643 of the ½ multiplier 641 and the output 646 of the 1/16 multiplier 642 are received by a second switch 645. The second switch 645 selects between its two inputs 643, 646 for connection to its output 644, which is added 647 to output 648 of the first switch 668 that has selected either the phase compensation signal 640 or the output 652 of the phase initializer 650. The adder 647 output 649 is received as the input to the phase initializer 650. Besides being connected to the first switch 668, the output 652 of the phase initializer is connected to a third switch 654 and to the input of the fraction processor 661. The third switch 654 selects between the phase initializer 650 output 652 and the sync patter 653, connecting the selected signal 655 to the input of a second adder 657. The second adder 657 adds the selected signal 655 to a transmit phase command signal 656 and to output 667 of a fourth switch 666. The output 658 of the second adder 657 is received by a third adder 659 that adds it to the output 662 to the fraction processor 661. The output 660 of the third adder 659 is the phase command received signal 660. The fourth switch 666 receives as inputs the output 611 of a phase filter 670 and the output 665 of a times 8 multiplier 664. The times 8 multiplier 664 receives as its input the sample ent signal 663, which is also subtracted from the output of the phase filter 670 by the fourth adder 668, whose output 669 is the input to the phase filter 670.

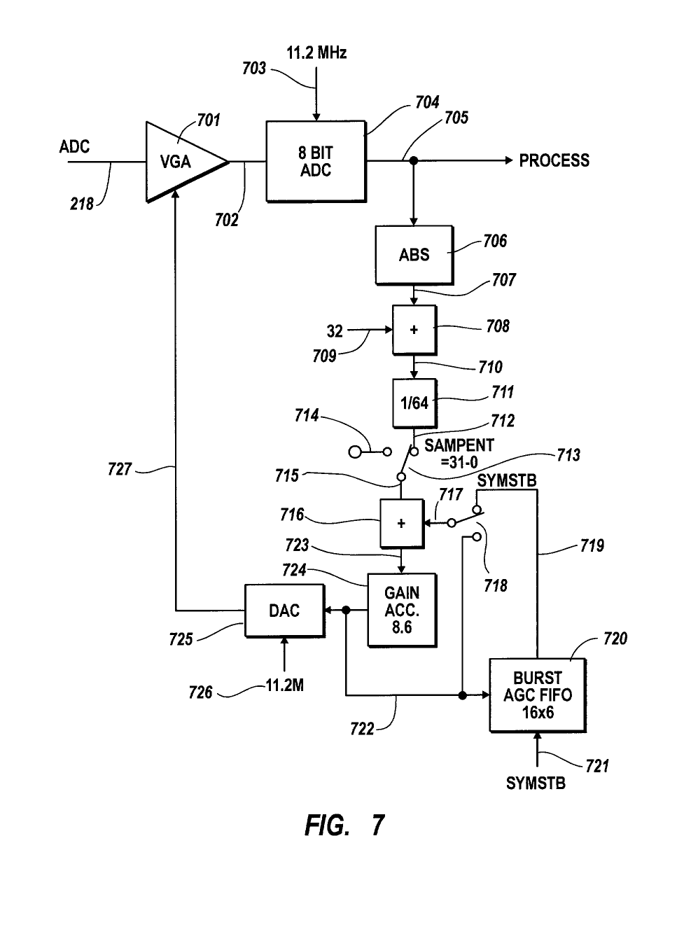

FIG. 7 is the detailed schematic diagram of the present embodiment of the automatic gain control circuit 217. Blocks 701, 704, 725 are external to 217, but are included herein to describe the entire system of some embodiments of this invention. The ADC signal 218 is received by a varible gain amplifier 701, which controlled by control signal 727 outputs an amplified signal 702. The amplified signal 702 is received by an 8-bit Analog to Digital Converter (ADC) 704, which in the present embodiment, is clocked at 11.2 MHz 703. The output 705 of the ADC 704 becomes the process output 232 and is an input to an absolute value circuit 706. The output 707 of the absolute value circuit 706 is subtracted 708 from the number 32 709. This difference 710 is then multiplied 711 by loop gain, currently 1/64 for the present sample times only. In alternative embodiments other values may be used to eliminate effects of burst codes and gain transients. This dividend 712 is connected as one input to a switch 713, the other input 714 of which is zero. The output 715 of the switch 713 is added 716 to the output of a second switch 718, whose inputs 719, 722 are the input 722 of the burst AGC FIFO 720 and the output 719 of the burst AGC FIFO 720, whose addressing is controlled by symstb 721. The sum 723 from the adder 716 is provided to a gain accumulator 724, the output 722 of which is the input to the burst AGC FIFO 720 and is the input to a digital to analog converter (DAC) 725, that is clocked at 11.2 MHz. The output 727 of the DAC 725 is the amplifier control previously described.

FIG. 8a shows the detailed circuit diagram of the present embodiment of the CRC. Through the use of this CRC circuit, data throughput is increased through dynamically defining the length of the CRC code. This CRC circuit, further, allows the time slots of a TDMA system to function independently of each other. This present embodiment uses an OFDM based system that uses TDMA for multiple access. This present embodiment is also adapted for use with an AC power line system, although it may be used with other communication channels, including other RF or “wired” RF communications channels. The CRC circuit is synchronized by the start of frame 817 and start of data 818 signals. Each frame consists of a number of time slots. The time slots correspond to the time division of the system, and time is shared in a token ring type of configuration. This particular embodiment has 17 data or time slots with the frame start signal resetting the value of the slot counter to one less than the number of slots and data counter to one less than the number of bits per slot, see FIG. 8a. The data start signal 818 decrements the slot counter 820 by one until it equals zero. The mode select 823 pin selects which CRC code to use. This embodiment of the invention accommodates a receiver and a transmitter with different control logic but similar functional designs. The transmitter resets and begins the CRC calculations when the transmit/receive signal 820 goes from low in one frame to high in the next frame and stops when the transmit/receive signal 820 goes from high to low in consecutive frames, see FIG. 8c. After the low to high transition of the transmit/receive signal 820, the CRC does not start until after the header portion of the packet, used in the receiver to start the CRC, has been transmitted. After the stop sequence occurs, the circuit outputs the CRC data that needs to be transmitted, and disrupts any original transmit data. The circuit outputs whatever number of bits necessary for particular mode selected; this particular embodiment uses a 30-bit and a 10-bit CRC code. The receiver starts CRC calculations after receiving the header that was transmitted in a particular slot. The header presently used is 2 A A 2 A A 0 0 1 in hexadecimal. Once the header is detected, the value of the CRC for that time slot is reset to zero. If the packet was received correctly, after the last bit of the appended CRC data is received the CRC register value for the appropriate slot will equal zero. If an error occurred during the packet, a non-zero value will be held in the CRC slot register value. The data on which the CRC is to be performed is inserted into the CRC calculation logic. When the next time slot occurs the current value of the CRC calculation is stored in the memory in the appropriate location, relative to the slot number, and the next time slot's calculation is retrieved from the memory. This process continues until the CRC is done. At this point the data is stored in the output memory, again in the location relative to slot number, and is held until transferred out through the output data line. Slot count is the counter 820 that contains the current slot number. Data start is the strobe that signals the beginning of the serial transmission of data. CRC mode selects 823, which CRC codes (10 or 30 bits in the present embodiment) to use on a particular slot. CRC enable 821, 807 is used to control when the CRC calculates. CRC mode 806 is received at the mode select of the CRC calculator 809 and of the second memory 812. Data 808 is received at the data input of the CRC calculator 809 and is connected to the second input of the output multiplexer 814. The output of the CRC calculator 809 PRLOUT is provided as the data input 803 of both the first memory 804 and the second memory 812. The data start 802 enables the first memory 804 and the CRC done 810 enables the second memory 812. The slot count 801 is received at the ADD input of a first memory 804 and the slot count 811 is received at the ADD input of the second memory 812. CRC data 813 is output from the second memory 812 and is input to the output multiplexer 814. The output 816 of the output multiplexer 814 is provided as output data, under control of the output count not equal zero 815.

FIGS. 8b and 8c show timing diagrams of the present embodiment of the CRC circuit, specifically showing the relationships of the signals frame start 817, data start 818, data counter 819, slot counter 820, CRC enable 821, CRC zero 822, mode select 823 CRC value slot 16, data 819, and transmit/receive 820 in the present embodiment.

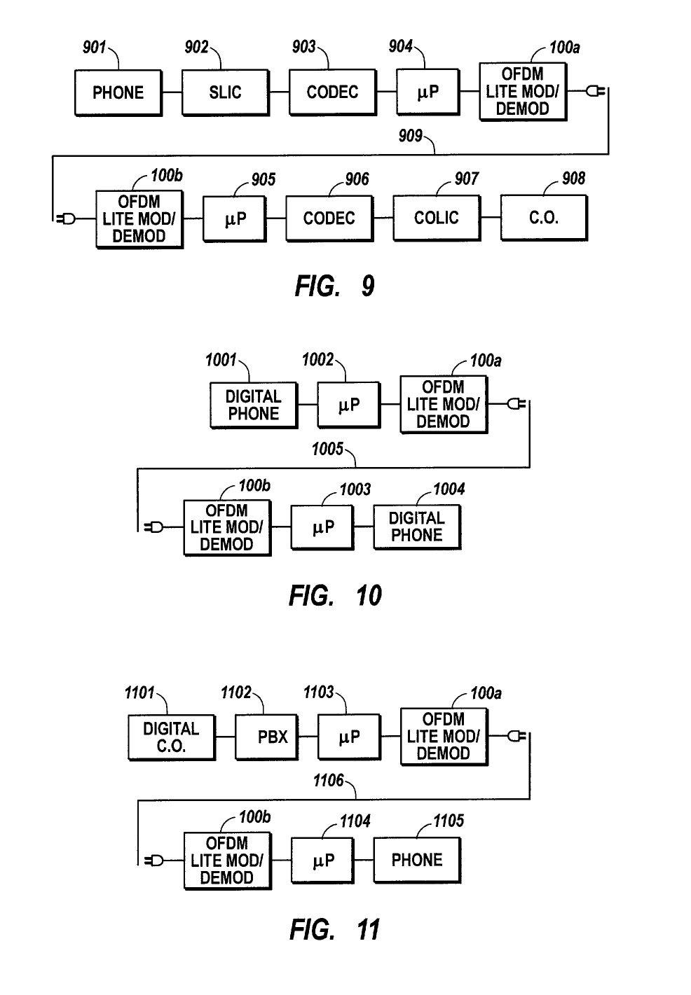

FIG. 9 shows a system block diagram of an analog telephony system incorporating the communication system of this invention. A standard telephone communication device 901 is connected to a subscriber line interface circuit (SLIC) 902 that is connected to a CODEC 903. The CODEC 903 is in electronic communication with a micro processor 904, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 909. The second OFDM communication modulator/demodulator 100b is in electronic communication with a second micro processor 905, which is connected to a second CODEC 906. The CODEC 906 is electronically connected to a central office line interface circuit (COLIC) 907 that is in communication with a standard central office 908.

FIG. 10 shows a system block diagram of a digital telephony system incorporating the communication system of this invention. A digital telephone communication device 1001 is connected to a micro processor 1002, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 1005. The second OFDM communication modulator/demodulator 100b is in electronic communication with a second micro processor 1003, which is connected to a digital central office or Internet connection 1004.

FIG. 11 is a system block diagram of a digital PBX system incorporating the communication system of this invention. A digital central office device 1101 is connected to a PBX 1102 that is in electronic communication with one or more micro processors 1103, which in turn is connected to one or more first OFDM communication modulator/demodulator of this invention 100a. In this embodiment the OFDM communication modulator/demodulators 100a are in communication with a second one or more OFDM communication modulator/demodulator 100b over a standard AC power line communication channel 1106. The second OFDM communication modulator/demodulator 100b is in electronic communication with one or more second micro processors 1104, which is connected to one or more standard telephone communication devices 1105.

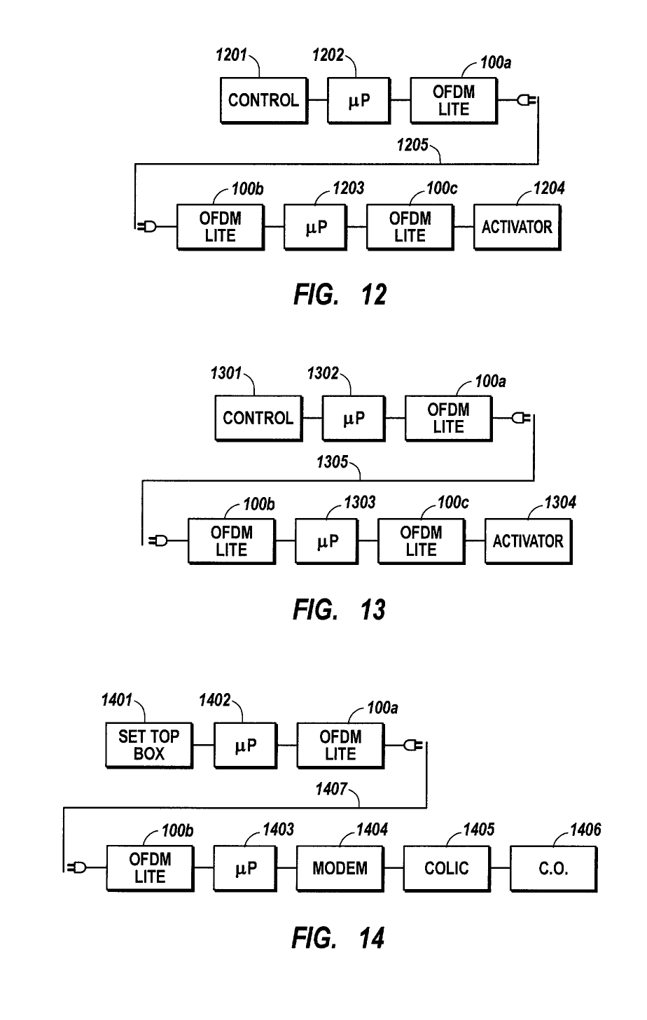

FIG. 12 is a system block diagram of a home automation system incorporating the communication system of this invention. A home device controller 1201 is in electronic communication with a micro processor 1202, which in turn is connected to a first OFDM communication modulator/demodulator of this invention 100a. Standard home device controllers include but are not necessarily limited to switches, computers, control panels, thermostats and display devices. In this embodiment the OFDM communication modulator/demodulator 100a is in communication with a second OFDM communication modulator/demodulator 100b over a standard AC power line communication channel 1205. The second OFDM communication modulator/demodulator 100b is in electronic communication with a second micro processor 1203, which is connected to a third OFDM communication modulator/demodulator 100c, which in turn is in communication with a device activator 1204. Typical devices activated by the device activator 1204 include but are not limited to appliances, light switches, air conditioning/heating thermostat controls and lawn and garden sprinklers.

FIG. 13 is a system block diagram of an industrial control system incorporating the communication system of this invention. An industrial controller 1301 is connected to a micro processor 1302, which in turn is connected to a first OFDM communication modulator/demodulator of this invention 100a. Typical industrial controller 1301 devices include but are not limited to switches, computers, control panels, thermostats, and display panels. In this embodiment the OFDM communication modulator/demodulator 100a is in communication with a second OFDM communication modulator/demodulator 100b over a standard AC power line communication channel 1305. The second OFDM communication modulator/demodulator 100b is in electronic communication with a second micro processor 1303, which is connected to a third OFDM communication modulator/demodulator 100c, which in turn is in communication with an industrial activator 1304. The typical industrial activator 1304 controls devices includes but is not limited to robot controllers, machine feedback, machine status, lighting controls.

FIG. 14 is a system block diagram of a set top box having a digital connection incorporating the communication system of this invention. A set top box device 1401 is provided in communication with a micro processor 1402, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 1407. The second OFDM communication modulator/demodulator 100b is in electronic communication with a second micro processor 1403, which is connected to a modem 1404. The modem 1404 is in electronic communication with a COLIC 1405 that is in communication with a central office 1406.

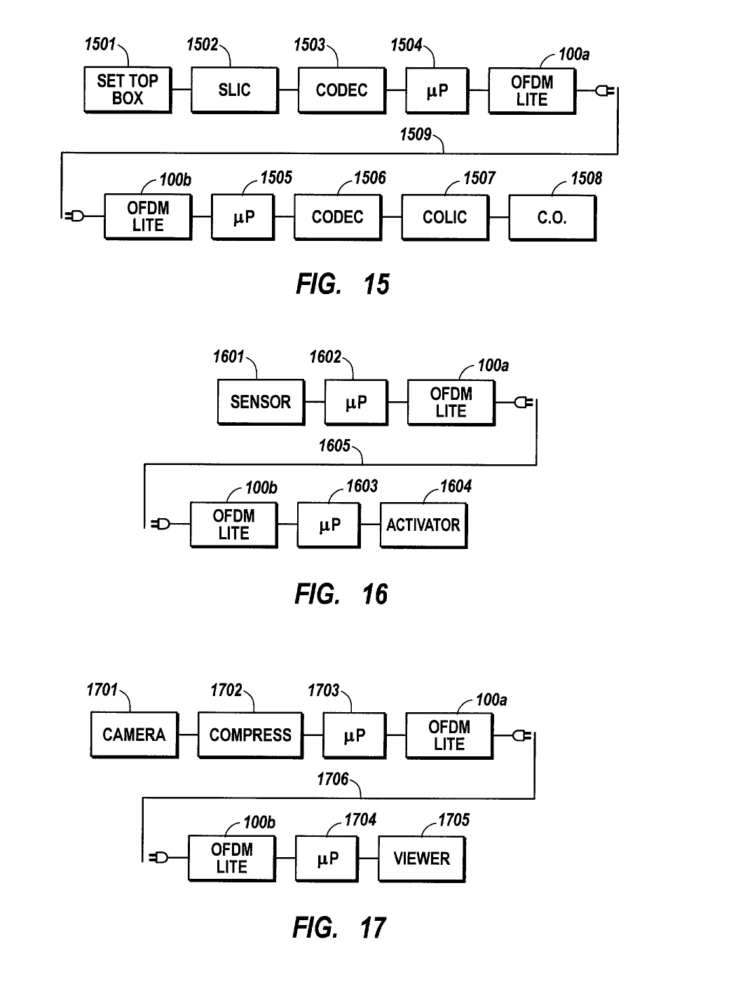

FIG. 15 is a system block diagram of a set top box having an analog connection incorporating the communication system of this invention. A set top box 1501 is provided connected to a subscriber line interface circuit (SLIC) 1502 that is connected to a CODEC 1503. The CODEC 1503 is in electronic communication with a micro processor 1504, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 11509. The second OFDM communication modulator/demodulator 100b is in electronic communication with a second micro processor 1505, which is connected to a second CODEC 1506. The CODEC 1506 is electronically connected to a central office like interface circuit (COLIC) 1507 that is in communication with a standard central office 1508.

FIG. 16 is a system block diagram of a security system incorporating the communication system of this invention. A sensor device 1601, such as a contact, heat or motion sensor, is in electronic communication with a micro processor 1602, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 1605. The second OFDM communication modulator/demodulator 100b is in electronic communication with a second micro processor 1603, which is connected to an activator 1604. A typical activator 1604 includes but is not limited to an alarm, lights, phone call connection, Internet warning alert and the like.

FIG. 17 is a system block diagram of a camera security system incorporating the communication system of this invention. A camera device 1701 is connected to a video/audio compression device 1702, which is in electronic communication with a micro processor 1703, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 1706. The second OFDM communication modulator/demodulator 100b is in electronic communication with a second micro processor 1704, which is connected to a viewer/recorder 1705. A typical view/recorder is a television, computer monitor, video tape or other recordable media device.

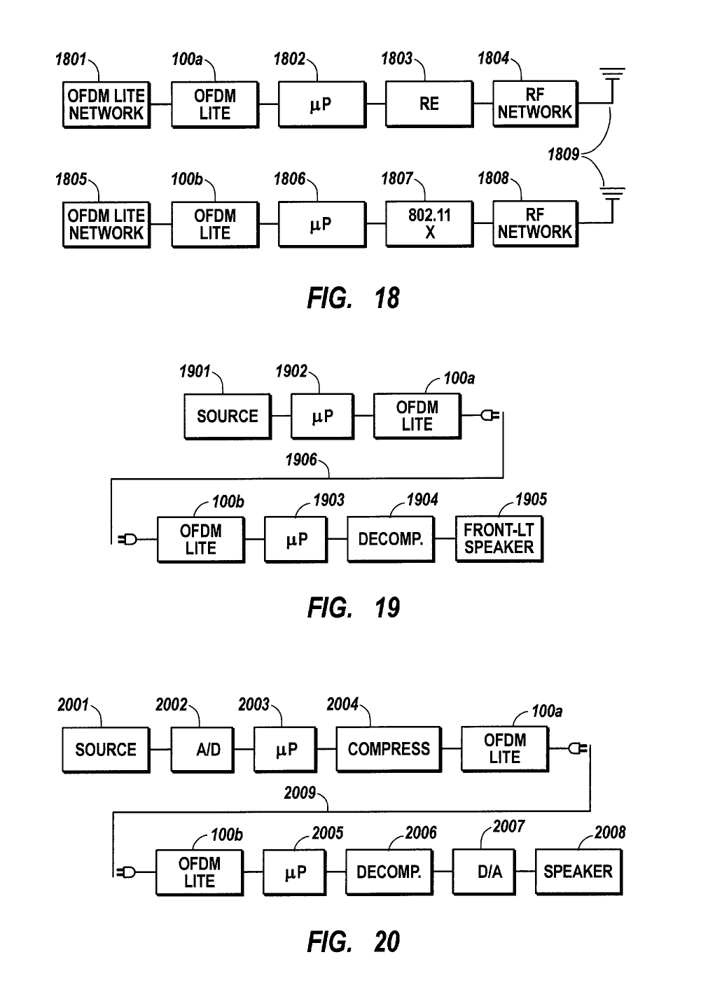

FIG. 18 is a system block diagram of a Bridge-RF system incorporating the communication system of this invention. An OFDM network connection 1801 is connected to a first OFDM communication modulator/demodulator of this invention 100a. The first OFDM communication modulator/demodulator is in electronic communication with a first micro processor 1802, which in turn is in communication with an RF modulator/demodulator 1803. The RF modulator/demodulator 1803 is electronically connected to an RF network 1804, that in this embodiment communicates over the air or through dedicated wiring. RF networks includes, but is not limited to those compatible with Bluetooth, CEBus, X-10, Ionworks, firewire, Ethernet, midi, USB, PCMCIA and PCI. Receiving the RF signal from the RF network 1804 of this embodiment is a 802.11x network 1808. The 802.11x network is in communication with an 802.11 x interface device 1807, which is in electronic communication with a second micro processor 1806. The second micro processor 1809 is connected to a second OFDM modulator/demodulator 100b, that in turn is in communication with a second OFDM network 1805.

FIG. 19 is a system block diagram of a home theater system incorporating the communication system of this invention. A signal source 1901 is connected to a first micro processor 1902, which in turn is connected to a first OFDM communication modulator/demodulator of this invention 100a. Typical home theater signal sources 1901 include but are not limited to television receivers, cable receivers, satellite receivers, video cameras, video cassette recorder/players, compact disc players, DVD players and computers. In this embodiment the OFDM communication modulator/demodulator 100a is in communication with a second OFDM communication modulator/demodulator 100b over a standard AC power line communication channel 1906. The second OFDM communication modulator/demodulator 100b is in electronic communication with a second micro processor 1903, which is connected to a second micro processor 1903. The second micro processor 1903 is in electronic communication with a video/audio decompression device 1904, that in turn is electronically connected to a display or speaker device 1905.

FIG. 20 is a system block diagram of a home audio system incorporating the communication system of this invention. An analog source device 2001 is in electronic communication with an analog-to-digital (A/D) converter 2002. The A/D 2002 is electronically connected to a first microprocessor 2003, which in turn is connected to a video/audio compression device 2004. The video/audio compression device 2004 is electronically connected to a first OFDM communication modulator/demodulator of this invention 100a. In this embodiment the OFDM communication modulator/demodulator 100a is in communication with a second OFDM communication modulator/demodulator 100b over a standard AC power line communication channel 2009. The second OFDM communication modulator/demodulator 100b is in electronic communication with a second micro processor 2005, which is connected to a decompression device 2006. The decompression device 2006 is in electronic communication with a digital-to-analog converter (D/A) 2007, which in turn is connected to a display/speaker device 2008.

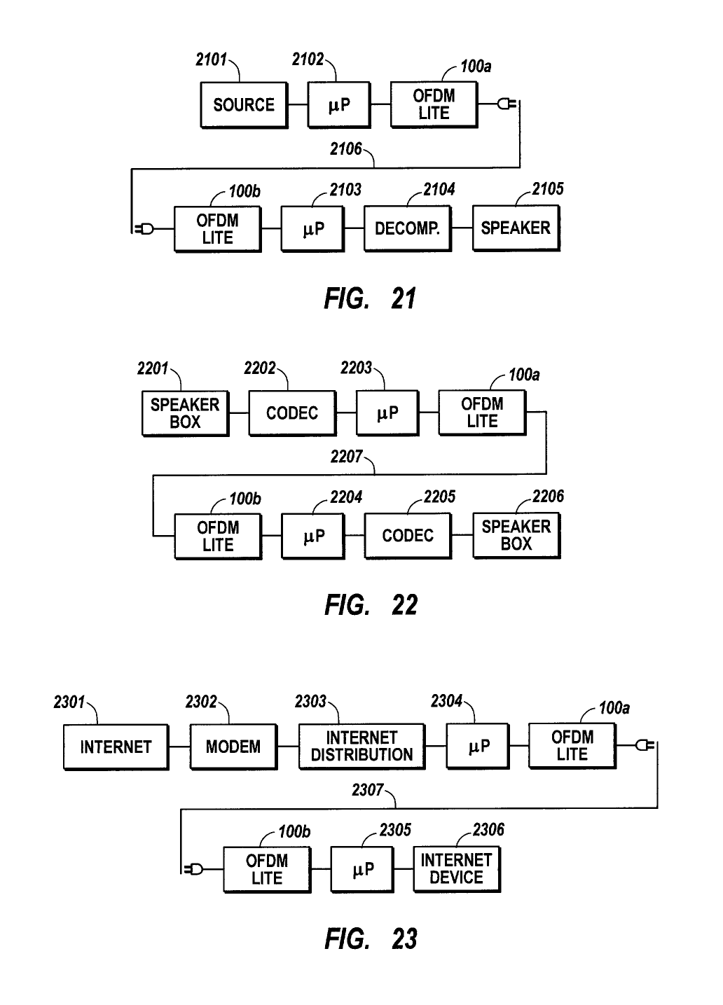

FIG. 21 is a system block diagram of a digital audio distribution system incorporating the communication system of this invention. A digital audio source 2101 is connected to a micro processor 2102, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 2106. The second OFDM communication modulator/demodulator 100b is in electronic communication with a second micro processor 905, which is connected to a second micro processor 2103. The second micro processor 2103 electronically communicates with a decompression device 2104, which in turn is in communication with an audio speaker 2105.

FIG. 22 is a system block diagram of an intercom system incorporating the communication system of this invention. A speaker box 2201 is connected to a CODEC 2202. The CODEC 2202 is in electronic communication with a first micro processor 2203, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 2207. The second OFDM communication modulator/demodulator 100b is in electronic communication with a second micro processor 2204, which is connected to a second CODEC 2205. The CODEC 2205 is electronically connected to speaker box 2206.

FIG. 23 is a system block diagram of an Internet distribution system incorporating the communication system of this invention. A standard Internet service 2301 is connected to an Internet communication device 2302, such as a modem or direct connection communication device, that is connected to an Internet distribution system 2303. The Internet distribution system 2303 is in electronic communication with a micro processor 2304, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 2307. The second OFDM communication modulator/demodulator 100b is in electronic communication with a second micro processor 2305, which is connected to an Internet device 2306.

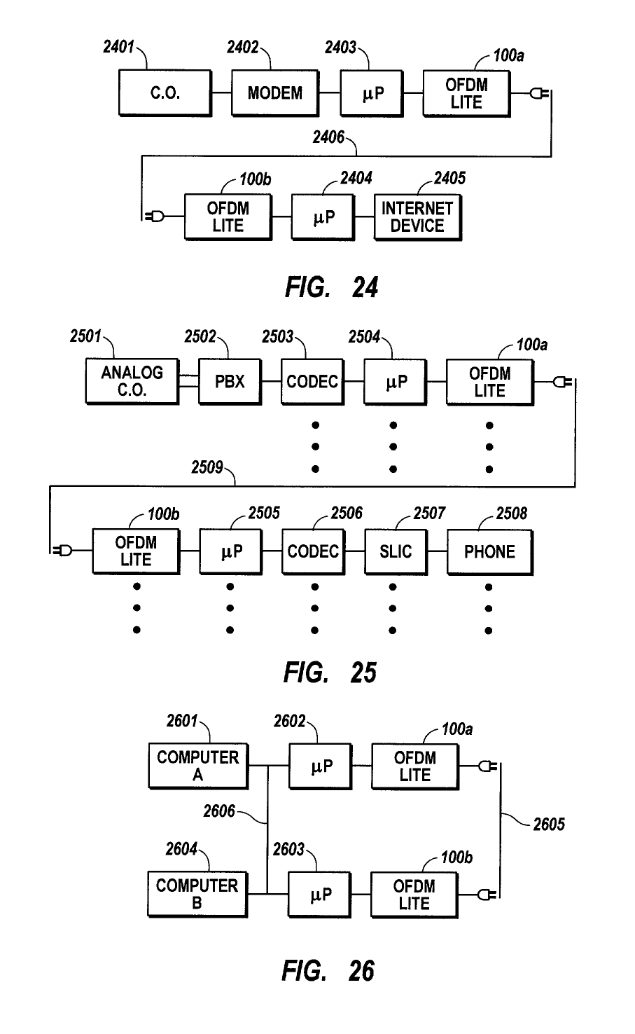

FIG. 24 is a system block diagram of an embedded modem system incorporating the communication system of this invention. A central office 2401 is connected to a modem 2402 that is connected to a micro processor 2403, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 2406. The second OFDM communication modulator/demodulator 100b is in electronic communication with a second micro processor 2404, which is connected to an Internet device 2405.

FIG. 25 is a system block diagram of a telephony/analog/PBX system incorporating the communication system of this invention. A analog central office 2501 is connected to a PBX 2502 that is connected to a CODEC 2503, which is connected to a micro processor 2505, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 2509. The second OFDM communication modulator/demodulator 100b is in electronic communication with a second micro processor 2505, which is connected to a CODEC 2506. The CODEC 2506 is electrically connected to a SLIC 2507 that is also connected to a standard telephone device 2508.

FIG. 26 is a system block diagram of a home networking system incorporating the communication system of this invention. A first computer device 2601 is connected to a micro processor 2602, which in turn is connected to a first OFDM communication modulator/demodulator of this invention 100a. In this embodiment the OFDM communication modulator/demodulator 100a is in communication with a second OFDM communication modulator/demodulator 100b over a standard AC power line communication channel 2605. The second OFDM communication modulator/demodulator 100b is in electronic communication with a second micro processor 2603, which is connected to a second computer device 2604. This embodiment of the invention further includes a second communication channel 2606 between the first 2601 and second 2604 computer devices. This communication channel 2606 may be a serial line, Ethernet, USB, parallel or the like and is provided to improve redundancy and efficiency of the network.

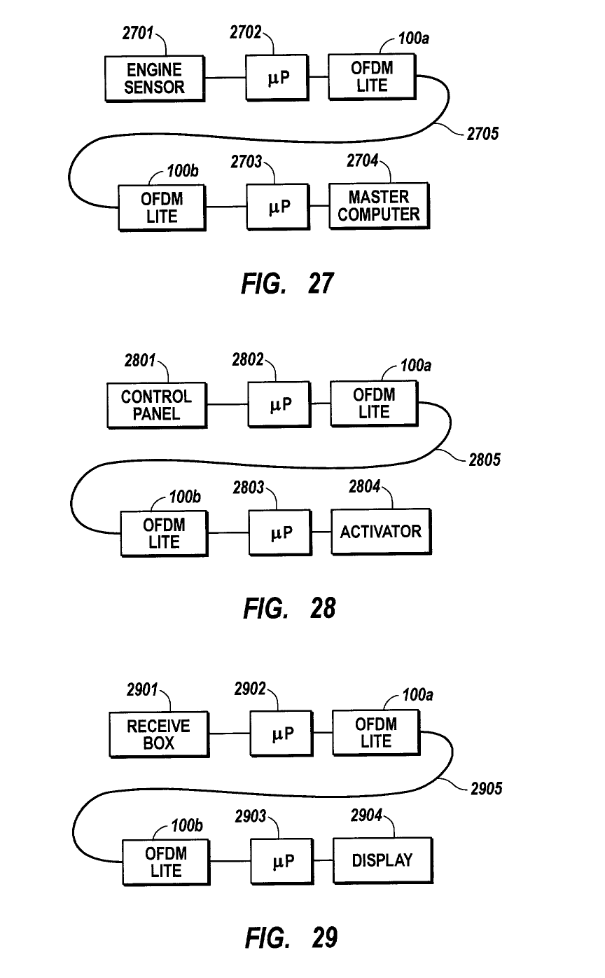

FIG. 27 is a system block diagram of an automobile sensor system incorporating the communication system of this invention. A automobile sensor 2701 is connected to a micro processor 2702, which in turn is connected to a first OFDM communication modulator/demodulator of this invention 100a. The typical automobile sensor includes but is not limited to an engine operation sensor, temperature sensor, brake feedback sensor, door and/or trunk latch sensor, oil pressure sensor, air pressure sensor. In this embodiment the OFDM communication modulator/demodulator 100a is in communication with a second OFDM communication modulator/demodulator 100b over the power wiring harness of the automobile 2705. The second OFDM communication modulator/demodulator 100b is in electronic communication with a second micro processor 2703, which is connected to a master computer 2704.

FIG. 28 is a system block diagram of an automobile control system incorporating the communication system of this invention. A control panel 2801 is connected to a micro processor 2802, which in turn is connected to a first OFDM communication modulator/demodulator of this invention 100a. In this embodiment the OFDM communication modulator/demodulator 100a is in communication with a second OFDM communication modulator/demodulator 100b over the automobile power wiring harness 2805. The second OFDM communication modulator/demodulator 100b is in electronic communication with a second micro processor 2803, which is connected to an activator 2804. Typical activators include, but are not necessarily limited to door locks, alarm activation, lights and window defrosters.

FIG. 29 is a system block diagram of an automobile navigation system incorporating the communication system of this invention. A receiver box 2901 is connected to a micro processor 2902, which in turn is connected to a first OFDM communication modulator/demodulator of this invention 100a. In this embodiment the OFDM communication modulator/demodulator 100a is in communication with a second OFDM communication modulator/demodulator 100b over the vehicle power harness as its communication channel 2905. The second OFDM communication modulator/demodulator 100b is in electronic communication with a second micro processor 2903, which is connected to a display device 2904.

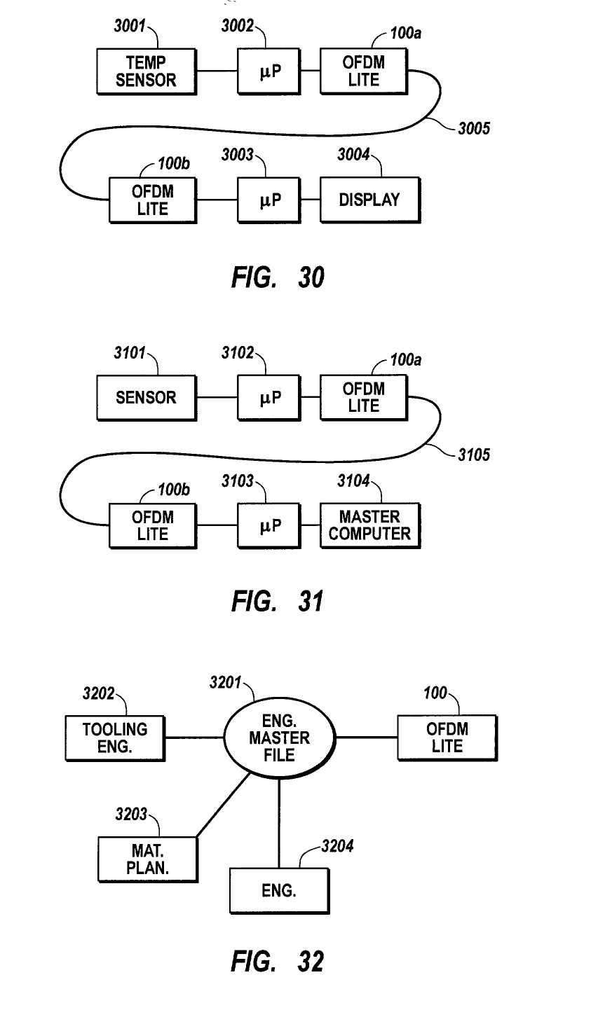

FIG. 30 is a first system block diagram of a truck sensor system incorporating the communication system of this invention. A truck sensor device 3001 is connected to a micro processor 3002, which in turn is connected to a first OFDM communication modulator/demodulator of this invention 100a. A typical truck sensor device 3001 includes but is not necessarily limited to engine operation sensor, temperature sensor, brake feedback sensor, door and/or trunk latch sensor, oil pressure sensor, air pressure sensor. In this embodiment the OFDM communication modulator/demodulator 100a is in communication with a second OFDM communication modulator/demodulator 100b over the vehicle power harness 3005. The second OFDM communication modulator/demodulator 100b is in electronic communication with a second micro processor 3003, which is connected to a display device 3004.

FIG. 31 is a second system block diagram of a truck sensor system incorporating the communication system of this invention. A truck sensor device 3101 is connected to a micro processor 3002, which in turn is connected to a first OFDM communication modulator/demodulator of this invention 100a. A typical truck sensor device 3101 includes but is not necessarily limited to a load sensor and a tie down sensor. In this embodiment the OFDM communication modulator/demodulator 100a is in communication with a second OFDM communication modulator/demodulator 100b over the vehicle power harness 3105. The second OFDM communication modulator/demodulator 100b is in electronic communication with a second micro processor 3103, which is connected to a display device 3104.

FIG. 32 is a system block diagram of a shop communications system incorporating the communication system of this invention. An engineering master file 3201 is provided to store information and to manage communication of information between a tooling engineering computer 3202, a materials planning computer 3203, an engineering computer 3204 and an external communication system 100 of this invention.

The described embodiment of this invention is to be considered in all respects only as illustrative and not as restrictive. Although specific code and electronic schematics are provided, the invention is not limited thereto. The scope of this invention is, therefore, indicated by the claims rather than by the foregoing description. All changes, which come within the meaning and range of equivalency of the claims, are to be embraced within their scope.

1. A system for providing a narrow band communication data link, comprising:
(A) a low speed converter for communicating with one or more standard communication devices;
(B) a data flow manager in electronic communication with said low speed converter;
(C) a signal processor in electronic communication with said data flow manager to provide a digital power line communication protocol;
(D) a high speed converter for communicating with a power line channel front end, said high speed converter in electronic communication with said signal processor; and
(E) a controller, to control the operation of the data line, said controller in electronic communication with said signal processor and said data flow manager.

2. A system for providing a narrow band communication data link, as recited in claim 1, wherein said signal processor further comprises:
(1) a filter and downsampler;
(2) a phase shifter in electronic communication with said filter and downsampler;
(3) a symbol accumulator receiving a summed version of data from said phase shifter;
(4) a symbol rate processor in electronic communication with said symbol rate processor; and
(5) a phase processor receiving data from said symbol rate processor and communicating with said phase shifter.

3. An analog telephony communication system, comprising:
(A) a telephone device;
(B) a processor in communication with said telephone device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a central office in communication with said narrow band communication link.

4. A digital telephony communication system, comprising:
(A) a digital telephone device;
(B) a processor in communication with said digital telephone device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a central office in communication with said narrow band communication link.

5. A digital PBX communication system, comprising:
(A) a telephone device;
(B) a processor in communication with said telephone device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager;
(D) a central office in communication with said narrow band communication link; and
(E) a PBX system in communication with said central office and said narrow band communication link.

6. A home automation communication system, comprising:
(A) a controller device;
(B) a processor in communication with said controller device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) an activator in communication with said narrow band communication link.

7. An industrial control communication system, comprising:
(A) a controller device;
(B) a processor in communication with said controller device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) an activator in communication with said narrow band communication link.

8. A set top box return path digital communication system, comprising:
(A) a set top box device;
(B) a processor in communication with said set top box device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a central office in communication with said narrow band communication link.

9. A set top box analog communication system, comprising:
(A) a set top box device;
(B) a processor in communication with said set top box device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a central office in communication with said narrow band communication link.

10. A security communication system, comprising:
(A) a sensor device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) an activator in communication with said narrow band communication link.

11. A camera security communication system, comprising:
(A) a camera device;
(B) a processor in communication with said camera device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) an image device in communication with said narrow band communication link, wherein said image device is selected from the group consisting of a display and an image storage device.

12. A bridge to RF communication system, comprising:
(A) an RF network device;
(B) a processor in communication with said RF network device; and
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager.

13. A home theater communication system, comprising:
(A) a signal source device;
(B) a processor in communication with said signal source device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a signal presentation device, wherein said signal presentation device is selected from a display and an audio speaker in communication with said narrow band communication link.

14. An analog home audio communication system, comprising:
(A) an audio source;
(B) a processor in communication with said telephone device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) an audio speaker in communication with said narrow band communication link.

15. An intercom communication system, comprising:
(A) a first speaker device;
(B) a processor in communication with said first speaker device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a second speaker in communication with said narrow band communication link.

16. An Internet distribution communication system, comprising:
(A) an Internet access device;
(B) a processor in communication with said Internet access device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) an Internet device in communication with said narrow band communication link.

17. An embedded modem communication system, comprising:
(A) a modem device;
(B) a processor in communication with said modem device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) an Internet device in communication with said narrow band communication link.

18. An analog PBX telephony communication system, comprising:
(A) an analog central office device;
(B) a PBX in communication with said analog central office device
(C) a processor in communication with said PBX device;
(D) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a telephone communication device in communication with said narrow band communication link.

19. A home networking communication system, comprising:
(A) a first computer device;
(B) a processor in communication with said first computer device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a second computer device in communication with said narrow band communication link.

20. An automobile sensor communication system, comprising:
(A) a sensor device;
(B) a processor in communication with said sensor device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a master computer in communication with said narrow band communication link.

21. An automobile control communication system, comprising:
(A) an automobile control panel device;
(B) a processor in communication with said automobile control panel device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) an activator in communication with said narrow band communication link.

22. An automobile navigation communication system, comprising:
(A) an automobile navigation receiver device;
(B) a processor in communication with said automobile navigation receiver device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a display device in communication with said narrow band communication link.

23. A trucking sensor communication system, comprising:
(A) a trucking sensor device;
(B) a processor in communication with said trucking sensor device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a display device in communication with said narrow band communication link.

24. A trucking sensor communication system, comprising:
(A) a trucking sensor device;
(B) a processor in communication with said trucking sensor device;
(C) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager; and
(D) a master computer in communication with said narrow band communication link.

25. A shop communication system, comprising:
(A) an engineering master file;
(B) a materials planning system in communication with said engineering master file;
(C) an engineering design system in communication with said engineering master file;
(D) a tooling engineering design system in communication with said engineering master file; and
(E) a narrow band communication link in communication with said processor, wherein said narrow band communication link further comprises:
(1) a low speed converter for communicating with one or more standard communication devices;
(2) a data flow manager in electronic communication with said low speed converter;
(3) a signal processor in electronic communication with said data flow manager to provide a digital power line communication protocol;
(4) a high speed converter for communicating with a power line channel front end, said high speed converter in electronic communication with said signal processor; and
(5) a controller, to control the operation of the data line, said controller in electronic communication with said signal processor and said data flow manager.

26. A phase shifter for use with a communication system, comprising a digital phase rotator, having an input, an output, and said communication system having a Digital Fast Fourier Transform in communication with said digital phase rotator.

27. A phase shifter for use with a communication system, comprising a digital phase rotator, having an input, an output and said communication system being an OFDM communication system in communication with said digital phase rotator.

28. A phase shifter for use with a communication system, comprising a digital phase rotator, having an input, an output and wherein said communication system further comprises a digital multi-tone frequency modulator in communication with said digital phase rotator.

29. A phase shifter for use in a communication system, as recited in claim 26, further comprising a first sense inverter, having an input and an output, said input of said first sense inverter being electrically connected to said output of said digital phase rotator.

30. A phase shifter for use in a communication system, as recited in claim 29, further comprising a first real shifter, having an input and an output, said input of said first real shifter being electrically connected to said output of said first sense inverter.

31. A phase shifter for use in a communication system, as recited in claim 30, further comprising a second sense inverter, having an input and an output, said input of said second sense inverter being electrically connected to said output of said first real shifter.

32. A phase shifter for use in a communication system, as recited in claim 31, further comprising a second real shifter, having an input and an output, said input of said second real shifter being electrically connected to said output of said second sense inverter.

33. A phase shifter for use with a communication system, comprising an equalizer, having an input, an output, and said communication system having a Digital Fast Fourier Transform in communication with said equalizer.

34. A phase shifter for use with a communication system, comprising an equalizer, having an input, an output and said communication system being an OFDM communication system in communication with said equalizer.

35. A phase shifter for use with a communication system, comprising an equalizer, having an input, an output and wherein said communication system further comprises a digital multi-tone frequency modulator in communication with said equalizer.

36. A phase shifter for use with a communication system, comprising an equalizer, having an input, an output and wherein said equalizer further comprises a forward error corrector in communication with said equalizer.

37. A communication system, comprising
(A) a digital phase rotator, having an input and an output separating a plurality of tones; and
(B) said communication system being a digital multi-tone modulated system.

38. A communication system, as recited in claim 37, wherein said communication system further comprises an AC power line communication channel.

39. A communication system, as recited in claim 37, further comprising an OFDM modulator.

40. A communication system, comprising:
(A) a sync processor, having an input and an output; and
(B) an ATC controller.

41. A communication system, as recited in claim 40, wherein said communication system further comprises an AC power line communication channel.

42. A communication system, as recited in claim 40, further comprising an OFDM modulator.

43. A communication system, comprising:
(A) an OFDM demodulator;
(B) a filter; and
(C) a receive phase generator.

44. A communication system, as recited in claim 43, wherein said communication system further comprises an AC power line communication channel.

45. A communication system, as recited in claim 43, further comprising an OFDM modulator.

46. A communication signal, comprising a frame further comprising a plurality of slots over a plurality of OFDM tones transmitted over the range of about 2 MHz to 3.5 MHz and having about 87.5 kHz separation.
